(19) United States
(12) Patent Application Publication
(10) Pub. No.: US 2005/0232658 A1
(43) Pub. Date: Oct. 20, 2005

(54) Member and method of sealing and storing photoreceptor and process cartridge for electrophotographic image forming apparatus

(76) Inventors: Toshiyuki Kabata, Yokohama-shi (JP); Michio Kimura, Numazu-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/105,405

(22) Filed: Apr. 14, 2005

(30) Foreign Application Priority Data
Apr. 14, 2004 (JP) 2004-119067
Dec. 13, 2004 (JP) 2004-360338
Jul. 9, 2004 (JP) 2004-202817
Jun. 15, 2004 (JP) 2004-176477

(51) Int. Cl. B32B 15/08; B32B 27/32; B29D 23/00; F16L 1/00; B32B 1/08; B65D 1/00; B29D 22/00; G03G 13/00; G03G 15/00; B32B 27/00

(52) U.S. Cl. 399/165; 428/523; 428/461; 428/35.7; 430/56

(57) ABSTRACT

A method of storing a photoreceptor or a process cartridge including the photoreceptor, wherein the photoreceptor or the process cartridge is stored in an environment having a temperature not higher than 23° C. for not less than an year after produced.

### BACKGROUND OF THE INVENTION

1. Field of the Invention

The present invention relates to a member and a method of sealing and storing a photoreceptor or a process cartridge detachably installed in an electrophotographic image forming apparatus such as a copier, a printer, a facsimile and a complex machine thereof.

2. Discussion of the Background

Typically, a photoconductive photoreceptor is used as an image bearer in an electrophotographic image forming apparatus such as an optical printer, an optical plotter and a facsimile, wherein the photoreceptor is charged with a charger; imagewise light is irradiated thereto to form an electrostatic latent image thereon; the electrostatic latent image is developed with a developer such as a toner to form a toner image thereon; the toner image is transferred onto a recording material such as a recording paper directly or indirectly through an intermediate transferer; and the toner image is fixed thereon with a fixer. The photoreceptor comes to an end of its life when abraded or an extraneous matter adheres thereto after producing substantial number of images, and has to be exchanged with a new photoreceptor. Photoreceptors for electrophotographic image forming apparatus usually differ in their length, diameters, shapes of the flanges, compositions and thickness according to the apparatus, and an exclusive photoreceptor is required for each apparatus. Further, the for electrophotographic image forming apparatus has been variously improved and many models thereof are being sold, and therefore a large number of photoreceptors have to be prepared by the manufacturers. The manufacturer has only to prepare a photoreceptor for the latest model if the use constantly replaced an old model therewith. However, not a few users who do not need high-resolution and high-quality images have no interest therein, and continue to use the same image forming apparatus for long periods for economic reasons and affinity thereto.

Some manufacturers unilaterally stops producing a photoreceptor after a specific period is passed since an image forming apparatus using the photoreceptor is no longer produced. However, the photoreceptor should be supplied as long as possible so long as users demand for the photoreceptor. However, since there is not so much demand for a photoreceptor for an old image forming apparatus, it is economically advantageous that a substantial number thereof are produced and stored to provide the photoreceptor on demand. In many cases, the photoreceptors for old image forming apparatus are produced using a chlorinated solvent such as dichloromethane. Recently, since the chlorinated solvent is restrictedly used for environmental reasons, it becomes difficult to continue to produce the photoreceptors for old image forming apparatus in future.

Sensitivities of photoreceptors tend to deteriorate as time passes after produced, and particularly photoreceptors prepared by using the chlorinated solvents, the residues of which desorb soon therein after produced, and photoreceptors using azo pigments as a charge generation material tend to have deteriorated sensitivities as time passes. In addition, image forming apparatus using a multilevel writing method tends to produce deteriorated images due to the sensitivity deterioration of photoreceptors.

As a method of preventing performance degradation of photoreceptors, Japanese Patent Publication No. 3-15738 discloses a storage method of maintaining electrostatic properties of photoreceptors, wherein a photoreceptor is contained in a container including an inactive gas or a deoxidizer to prevent a reaction between oxygen and a charge generation material included in the photoreceptor. However, this storage method is effectively used to store photoreceptors for several months, but is unreliable because sensitivities thereof often deteriorate when stored for long periods, i.e., not less than an year.

Japanese Laid-Open Patent Publication No. 2000-7048 discloses a method of storing a photoreceptor in a bag having low moisture permeability. However, this storage method is effectively used to prevent a photosensitive layer of the photoreceptor from separating therefrom in an environment of high humidity, but is insufficient for the sensitivity deterioration of photoreceptors when stored for long periods, i.e., not less than an year.

Japanese Laid-Open Patent Publication No. 2001-183858 discloses a storage method of adhering an antioxidant to the surface of a photoreceptor. However, this storage method can prevent a reaction between oxygen and a charge generation material included in the photoreceptor, but is not preferably used because the antioxidant excessively adhered thereto causes increase of a residual potential thereof.

Because of these reasons, a need exists for a method of storing photoreceptors for long periods without sensitivity deterioration. However, a guarantee period thereof is typically about an year after produced.

### SUMMARY OF THE INVENTION

Accordingly, one object of the present invention is to provide a method of storing a photoreceptor or a process cartridge including a photoreceptor without sensitivity deterioration even when stored for long periods, i.e., not less than an year.

Another object of the present invention is to provide a member of storing a photoreceptor or a process cartridge including a photoreceptor without sensitivity deterioration even when stored for long periods, i.e., not less than an year.

A further object of the present invention is to provide a photoreceptor or a process cartridge without sensitivity deterioration even after stored for long periods, i.e., not less than an year.

These objects and other objects of the present invention, either individually or collectively, have been satisfied by the discovery of a method of storing a photoconductive photoreceptor and a process cartridge including the photoconductive photoreceptor, wherein the photoconductive photoreceptor and the process cartridge are stored in an environment of a temperature not higher than 23° C. for not less than an year.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is an oblique perspective view illustrating an embodiment of the storage member of the present invention;

FIG. 2 is an oblique perspective view illustrating another embodiment of the storage member of the present invention;

FIG. 3 is a schematic perspective view illustrating a whole image forming apparatus; and

FIG. 4 is a cross-sectional view illustrating a process cartridge set in the image forming apparatus in FIG. 3.

### DETAILED DESCRIPTION OF THE INVENTION

The present invention provides a method of storing a photoconductive photoreceptor and a process cartridge including the photoconductive photoreceptor for not less than an year, wherein the photoconductive photoreceptor and the process cartridge are stored in an environment of a temperature not higher than 23° C.

The present inventors studied in detail why photoconductive photoreceptors have deteriorated sensitivities when stored for long periods to find that a reaction between a charge generation material included therein and oxygen, or a oxidizing or a reducing gas in the air; or a reaction between the charge generation material and a solvent, an oxidizing gas or a reducing gas releasing from a storage container in quite a small amount; and a sublimation of an additive such as an antioxidant included therein, very slowly change the photoreceptors. Since a velocity of a chemical reaction is typically a function of temperature and a type of Arrhenius, the present inventors studied whether a change velocity of a photoreceptor can be slowed when the photoreceptor is stored at a temperature lower than a room temperature for long periods. As a result, the present inventors discovered that photoreceptors hardly have deteriorated sensitivities when stored at 23° C. even in the air for long periods, i.e., not less than an year. Namely, the present invention is a method of storing a photoreceptor or a process cartridge for not less than an year after produced, wherein the photoreceptor or process cartridge is stored in an environment having a temperature not higher than 23° C. The photoreceptor or process cartridge of the present invention is preferably stored at not higher than 23° C. for not less than an year. However, when the storage temperature becomes higher than 23° C. due to an inspection of the storage facility, etc., such a period wherein the temperature is higher than 23° C. is preferably not longer than 30 days, more preferably not longer than 15 days, and furthermore preferably not longer than 10 days totally. The temperature higher than 23° C. is preferably not higher than 43° C., more preferably not higher than 38° C., and furthermore preferably not higher than 35° C.

The photoreceptor or process cartridge of the present invention is preferably stored at not higher than 23° C., more preferably from −40 to 20° C., and furthermore preferably from −20 to 18° C. so as not to have deteriorated sensitivity even when stored for not less than an year. A photoreceptor or a process cartridge including a photoreceptor has deteriorated sensitivity when stored at higher than 23° C. for not less than an year.

The photoreceptor or process cartridge of the present invention is preferably stored for not less than an year, more preferably not less than 1.5 years, and furthermore preferably from 2 to 7 years. When stored for less than an year, a photoreceptor or a process cartridge including a photoreceptor need not be stored by the method of the present invention because sensitivity deterioration thereof does not lead to a serious problem.

Since the method of storing a photoreceptor or a process cartridge of the present invention has a low storage temperature, a storage humidity need not particularly be controlled unless particularly high because an absolute humidity is low. However, the photoreceptor or process cartridge is preferably contained in a storage member such as a buffer material, a bag and a box to protect the photoreceptor or process cartridge from a dust and a mechanical impact.

In the photoreceptor or process cartridge of the present invention, when the storage temperature is increased to a room temperature, a humidity around the photoreceptor is fully considered and the temperature needs to be gradually increased because the photoreceptor tends to have a ripped layer and deteriorated sensitivity due to dew condensation. The photoreceptor or process cartridge is preferably sealed in a damp proof container or bag because of being free from dew condensation, able to be actually used sooner after stored, and free from ripped layer and deteriorated sensitivity.

Specific examples of a container for storing the photoreceptor or process cartridge include a resin container, a metallic container, a glass container and their complex or multilayered container. The photoreceptor or process cartridge is preferably sealed with a resin film in terms of handling, sealing and containing. Specific examples of the resin film include polyolefin films such as polyethylene, polypropylene, and ionomer; or multilayered films layering resins such as nylon (registered mark), polyester and ethylene vinyl alcohol, and metallic films thereon to impart mechanical strength and gas cutoff performance thereto. Specific examples of the metallic films include aluminum, gold, silver and nickel which are extendable, flexible, pinhole-less and free from gas permeation. Particularly, the aluminum is preferably used in terms of its economical efficiency, workability, mechanical property. When the photoreceptor or process cartridge is sealed in a resin film as a storage member, the photoreceptor or process cartridge can be sealed with a slide fastener, a heat seal or an ultrasonic welding. The heat seal is preferably used in consideration of its sealing workability and airtightness, and the polyolefin is preferably used for its fusion-bonded layer.

When the photoreceptor is sealed in a polyolefin film and stored for long periods, its sensitivity deterioration differs depending on types of the polyolefin films. Specifically, the more impurities therein, the worse the sensitivity deterioration. However, the impurities which are solid, and neither volatile nor sublime, less deteriorate the sensitivities of photoreceptors. Namely, volatile or sublime organic compounds having comparatively a low molecular weight largely deteriorate the sensitivities of photoreceptors.

Specifically, when an extract from the polyolefin film with n-hexane is preferably not greater than 1,300 ppm, more preferably not greater than 1,000 ppm, and furthermore preferably from 10 to 700 ppm, the photoreceptor less and less has deteriorated sensitivity.

Specific examples of the polyolefin films include polyethylene, polypropylene, ionomer polyethylene and vinylacetate-modified polyethylene. The polyethylene and ionomer polyethylene are preferably used in terms of their workability and heat-sealing performance. Further, the polyethylene is more preferably used in terms of its economical efficiency.

Specific examples of the polyethylene include a high-pressure processed low-density polyethylene, a linear short-chain branch polyethylene, a medium-pressure processed high-density polyester and a linear short-chain branch polyethylene using metallocene as a catalyst. These polyethylenes need a polymerization initiator and a catalyst. The polyolefin films typically include a variety of additives when processed. Specific examples of the additives include antioxidants such as a phenolic antioxidant, a sulfuric antioxidant and a phosphorous antioxidant to prevent the polyolefin films from being oxidized in an inflation process wherein the polyolefin films are melted upon application of heat at from 140 to 190° C.; and lubricants such as a fatty acidic lubricant and a fatty amidic lubricant imparting releasability thereto to improve abrasion resistance and productivity thereof. In addition, anti-blocking agents such as a synthesized silica and a silica are included therein such that a storage member formed of the polyolefin film can easily be opened to take a photoreceptor therein. Further, carbons, etc. are also included therein to impart a light blocking effect thereto.

The polyolefin film including an extract not greater than 1,300 μm when subjected to n-hexane can prevent the photoreceptor or process cartridge included therein from being deteriorated in sensitivity for long periods in the present invention. The extract when subjected to n-hexane includes a fatty acid derivative, a wax grease, a petroleum hydrocarbon, etc., which are extracted products from the polyolefin film with the n-hexane, which is a solvent. Specific examples of the extract when subjected to n-hexane include low-molecular-weight organic compounds produced when the polyolefin is prepared, low-molecular-weight components thereof, a variety of organic additives and their resolvable products, etc., which deteriorate sensitivity of the photoreceptor.

As mentioned above, resin films such as polyester, nylon and ethylene vinyl alcohol; and metallic films such as aluminum are laminated on the polyolefin films through an adhesive layer in many cases to improve mechanical properties and gas barrier performances.

Particularly, the gas barrier performances thereof become complete when the metallic films are laminated thereon, and therefore it is expected that sensitivity deterioration of a photoreceptor sealed in such a polyolefin film due to an oxidizing, a reducing gas or water, or due to loss of a small amount of an additive or a residual solvent therein can be prevented.

However, when photoreceptors are sealed and stored in a marketed polyolefin film including a metallic film laminated thereon, sensitivity thereof deteriorate in many cases particularly at a temperature higher than room temperature.

The present inventors discovered that an adhesive layer between the polyolefin film and a metallic film includes an organic solvent such as esters diluting polyester adhesives and polyether adhesives having good adhesion performances between films, and that the organic solvent gradually diffuse therefrom. Particularly, when ethyl acetate is used as an organic solvent, esters adhere to or are absorbed in the photoreceptors, resulting in deterioration of sensitivity thereof. At the same time, the esters are hydrolyzed with humidity in the air, and become alcohols and carboxylic acids more deteriorating sensitivity thereof. Typically, an organic solvent in a storage member for foods, which is formed of a polyolefin film and a metallic film laminated thereon, is not harmful to human bodies. However, when a photoreceptor is stored therein for long periods, even a small amount of the organic solvent deteriorates sensitivity thereof without escaping therefrom.

When photoreceptors or process cartridges are stored for long periods, it is very important to choose storage members. The present inventors discovered that a storage bag formed of a polyolefin film and a metallic film with an adhesive layer therebetween, wherein the polyolefin film and adhesive layer located inside the metallic film include an organic solvent having a boiling point not higher than 120° C. and a concentration not greater than 120 ppm, does not cause sensitivity deterioration of the photoreceptors.

Specific examples of adhesives for use in the adhesive layer between the polyolefin film and metallic film include polyester adhesives polyether adhesives. The adhesive layer preferably has a thickness of from 0.1 to 10 μm, more preferably from 0.5 to 5.0 μm, and furthermore preferably from 1.0 to 4.0 μm. When less than 0.1 μm, some parts between the polyolefin film and metallic film tend to insufficiently adhere to each other. When greater than 10 μm, the polyolefin film and metallic film tend to be separate from each other, and sealing performance of the resultant storage member deteriorates.

The adhesive layer is formed by diluting the above-mentioned adhesives with organic solvents such as ethers, alcohols and ketones having a boiling point not higher than 120° C.; and coating the diluted adhesive on the polyolefin film or the metallic film. When the organic solvent has a boiling point higher than 120° C., it becomes difficult to remove the solvent after the adhesive layer is formed. Therefore, the solvent penetrates the polyolefin film to the photoreceptor, resulting in sensitivity deterioration thereof and mechanical deterioration of a surface thereof. In addition, the solvent deteriorates in its adhesive reducibility.

Specific examples of the solvents diluting the adhesives include methanol, isopropyl alcohol, isobutyl alcohol, n-butyl alcohol, ethyl acetate, isobutyl acetate, ethanol, acetone, methyl ethyl ketone and methyl isobutyl ketone. The ethyl acetate is most preferably used in consideration of solubility and coatability of the adhesive. Since gases from the solvents cause sensitivity deterioration of photoreceptors when contacted thereto for long periods, the solvent in the storage member needs to have a minimum concentration.

Therefore, the organic solvent having a boiling point not higher than 120° C., included in the polyolefin film and adhesive layer located inside the metallic film, preferably has a concentration not greater than 120 ppm, more preferably not greater than 70 ppm, and furthermore preferably from 2 to 40 ppm. When greater than 120 ppm, the photoreceptor largely deteriorates in its sensitivity. Since hydrolyzed products of the ethyl acetate, i.e., an acetic aid and an ethanol also largely deteriorate sensitivity of the photoreceptor, a total concentration of the ethyl acetate, acetic acid and ethanol has to be not greater than 120 ppm.

The higher the temperature, the more the organic solvent from the storage member. Therefore, the photoreceptor or process cartridge is preferably stored at not higher than 23° C., more preferably from −40 to 20° C., and furthermore preferably from −20 to 18° C.

The photoreceptor or process cartridge of the present invention is preferably stored at not higher than 23° C. for not less than an year. However, when the storage temperature becomes higher than 23° C. due to an inspection of the storage facility, etc., such a period wherein the temperature is higher than 23° C. is preferably not longer than 30 days, more preferably not longer than 15 days, and furthermore preferably not longer than 10 days totally. The temperature higher than 23° C. is preferably not higher than 43° C., more preferably not higher than 38° C., and furthermore preferably not higher than 35° C.

To have the organic solvent having a boiling point not higher than 120° C., included in the polyolefin film and adhesive layer located inside the metallic film, have a concentration not greater than 120 ppm, it is preferable that the storage member is fully dried, and is optionally dried under reduced pressure to decrease the solvent.

The storage member for use in storing the photoreceptor and process cartridge of the present invention preferably includes a plastic film such as a polyester film and a nylon film located outside the metallic film to protect the storage member and to improve printability thereof. Since an adhesive layer is formed as well between the metallic film and plastic film, and a metal foil of the metallic film works as a block layer such that the photoreceptor and a gas from the organic solvent do not contact each other. Therefore, the photoreceptor scarcely deteriorates in its sensitivity even after stored for long periods.

When a photoreceptor is stored in the polyolefin film, the photoreceptor is sealed therein. When stored for several months, the photoreceptor does not deteriorate so much in its sensitivity. However, when stored for long periods, i.e., not less than an year, even a small amount of the organic solvent gas deteriorates sensitivity of the photoreceptor because of not escaping from the sealed space. Therefore, it is very important to choose the polyolefin film when storing the photoreceptor or process cartridge for long periods.

It is most preferable that the adhesive layer does not include an organic solvent at all.

Specific examples of methods of bonding the metallic film with the polyolefin film without using the organic solvent include a polylaminating method extruding and laminating the melted polyolefin film on a film without forming an adhesive layer; a non-solvent laminating method controlling viscosity of an adhesive upon with only a heat, and coating the adhesive to form an adhesive layer; and a poly-sand laminating method molding a melted polyolefin film between the polyolefin film and a laminating film. These storage members are preferably used because of scarcely causing sensitivity deterioration of the photoreceptor except for their specific equipment and slightly worse adhesiveness between the metallic film and polyolefin film than the above-mentioned adhesive layer forming method using the organic solvent.

An image forming apparatus using the photoreceptor or process cartridge of the present invention preferably uses a multilevel writing method. When the writing method is binary, or more or less binary, the photoreceptor scarcely produces poor images unless sensitivity thereof largely varies. The multilevel writing method can faithfully reproduce halftone images such as photo images. However, when the photoreceptor deteriorates in its sensitivity, the resultant images have unnatural colors. Therefore, it is essential to use the photoreceptor or process cartridge of the present invention for the image forming apparatus using the multilevel writing method.

The photoreceptor of the present invention includes a photosensitive layer on an electroconductive substrate. The photosensitive layer includes a single-layered photosensitive layer wherein a charge generation material ad a charge transport material are mixed, an orderly-layered photosensitive layer wherein a charge transport layer is formed on a charge generation layer and a reverse-layered photosensitive layer wherein a charge generation layer is formed on a charge transport layer. A protective layer can be formed on the photosensitive layer. An undercoat layer may be formed between the photosensitive layer and the electroconductive substrate. In addition, the respective layers can optionally include a proper amount of an additive such as a plasticizer, an antioxidant and a leveling agent.

Suitable materials as the electroconductive substrate include materials having a volume resistance not greater than 10¹⁰ Ω·cm. Specific examples of such materials include plastic cylinders, plastic films or paper sheets, on the surface of which a metal such as aluminum, nickel, chromium, nichrome, copper, gold, silver, platinum and the like, or a metal oxide such as tin oxides, indium oxides and the like, is deposited or sputtered. In addition, a plate of a metal such as aluminum, aluminum alloys, nickel and stainless steel and a metal cylinder, which is prepared by tubing a metal such as the metals mentioned above by a method such as drawing ironing, impact ironing, extruded ironing and extruded drawing, and then treating the surface of the tube by cutting, super finishing, polishing and the like treatments, can also be used as the substrate. In addition, the endless nickel belt and endless stainless belt disclosed in Japanese Laid-Open Patent Publication No. 52-36016 can also be used as the electroconductive substrate.

An endless-belt-shaped photoreceptor exposes a cut sectional side in many cases because it is prepared by widely forming a photosensitive layer on the belt and cutting an edge thereof to have a width to practically be used. A moisture infiltrates through the sectional side to separate the photosensitive layer from the belt, resulting in deterioration of durability and sensitivity of the photoreceptor. Therefore, it is very important to consider the moisture infiltration while stored and dew condensation when the environmental temperature rises from a temperature to a room temperature. Therefore, the photoreceptor or process cartridge is preferably sealed in a film having less moisture permeability, and is more preferably sealed in a polyolefin film laminated with a metallic film such as an aluminum film having little moisture permeability.

The undercoat of the photoreceptor of the present invention includes a resin, a mixture of a white pigment and a resin or an oxidized metallic film which is a chemically or electrically oxidized surface of the electroconductive substrate, among which the mixture of a white pigment and a resin is preferably used. Specific examples of the white pigment include metal oxides such as a titanium oxide, an aluminum oxide, a zirconium oxide and a zinc oxide, among which the titanium oxide preventing a charge from being injected to the undercoat layer from the electroconductive substrate is preferably included therein. Specific examples of the resin for use therein include thermoplastic resins such as polyamide, polyvinylalcohol, casein and methylcellulose; and thermosetting resins such as an acrylic resin, a phenol resin, a melamine resin, an alkyd resin, an unsaturated polyester resin and an epoxy resin. These can be used alone or in combination.

Specific examples of the charge generation material include azo pigments such as monoazo pigments, bisazo pigments, trisazo pigments and tetrakisazo pigments; organic pigments and dyes such as triarylmethane dyes, thiazine dyes, oxazine dyes, xanthene dyes, cyanine dyes, styryl dyes, pyrylium dyes, quinacridone dyes, indigo dyes, perylene dyes, polycyclic quinone pigments, bisbenzimidazole pigments, indanthrone pigments, Squarilium pigments and phthalocyanine pigments; and inorganic materials such as serene, serene-arsenic, serene-tellurium, cadmium sulfide, zinc oxide, titanium oxide and amorphous silicone. These charge generation materials can be used alone or in combination. Particularly, since the azo pigments are often used for the photoreceptors in image forming apparatus using multilevel writing methods and are not highly resistant against oxidizing gases, the storage method of the present invention is effectively used for the photoreceptors including the azo pigments.

Specific examples of the charge transport material for use in the photoreceptor of the present invention include anthracene derivatives, pyrene derivatives, carbazole derivatives, tetrazole derivatives, metallocene derivatives, phenothiazine derivatives, pyrazoline derivatives, hydrazone compounds, styryl compounds, styryl hydrazone compounds, enamine compounds, butadiene compounds, distyryl compounds, oxazole compounds, oxadiazole compounds, thiazole compounds, imidazole compounds, triphenylamine derivatives, phenylenediamine derivatives, aminostilbene derivatives, triphenylmethane derivatives, etc. These can be used alone or in combination.

Specific examples of a binder resin for use in forming the photosensitive layer including the charge generation layer and the charge transport layer include, but are not limited to, insulative thermoplastic resins such as polyvinylchloride, polyvinylidenechloride, vinylchloride-vinylacetate copolymers, vinylchloride-vinylacetate-maleic anhydride copolymers, ethylene-vinylacetate copolymers, polyvinylbutyral, polyvinylacetal, polyester, phenoxy resins, (metha)acrylic resins, polystyrene, polycarbonate, polyarylate, polysulfone, polyethersulfone and ABS resins; thermosetting resins such as phenol resins, epoxy resins, urethane resins, melamine resins, isocyanate resins, alkyd resins, silicone resins and thermosetting acrylic resins; and photoconductive resins such as polyvinyl carbazole, polyvinyl anthracene and polyvinyl pyrene. These can be used alone or in combination.

Specific examples of the antioxidant include monophenolic compounds such as 2,6-di-t-butyl-p-cresol, butylated hydroxyanisole, 2,6-di-t-butyl-4-ethylphenol, n-octadecyl-3-(4′-hydroxy-3′ 5′-di-t-butylphenol) and 3-t-butyl-4-hydroxyanisole; bisphenolic compounds such as 2,2′-methylene-bis-(4-methyl-6-t-butylphenol), 2,2′-methylene-bis-(4-ethyl-6-t-butylphenol), 4,4′-thiobis-(3-methyl-6-t-butylphenol) and 4,4′-butylidenebis-(3-methyl-6-t-butylphenol); phenolic polymer compounds such as 1,1,3-tris-(2-methyl-4-hydroxy-5-t-butylphenyl)butane, 1,3,5-trimethyl-2,4,6-tris(3,5-di-t-butyl-4-hydroxybenzyl)benzene, tetrakis-[methylene-3-(3′,5′-di-t-butyl-4′-hydroxyphenyl)propionate]methane, bis[3,3′-bis(4′-hydroxy-3′-t-butylphenyl)butyric acid]glycol ester and tocophenol compounds; paraphenylenediamine compounds such as N-phenyl-N′-isopropyl-p-phenylenediamine, N,N′-di-sec-butyl-p-phenylenediamine, N-phenyl-N-sec-butyl-p-phenylenediamine, N,N′-di-isopropyl-p-phenylenediamine and N,N′-dimethyl-N,N′-di-t-butyl-p-phenylenediamine; hydroquinone compounds such as 2,5-di-t-octylhydroquinone, 2,6-didodecylhydroquinone, 2-dodecylhydroquinone, 2-dodecyl-5-chlorohydroquinone, 2-t-octyl-5-methylhydroquinone and 2-(2-octadecenyl)-5-methylhydroquinone; organic sulfur-containing compounds such as dilauryl-3,3′-thiodipropionate, distearyl-3,3′-thiodipropionate and ditetradecyl-3,3′-thiodipropionate; and organic phosphorus-containing compounds such as triphenylphosphine, tri(nonylphenyl)phosphine, tri(dinonylphenyl)phosphine, tricresylphosphine and tri(2,4-dibutylphenoxy)phosphine.

The charge transport layer may optionally include a plasticizer and a leveling agent.

Specific examples of the plasticizer include plasticizers for typical resins, such as dibutylphthalate and dioctylphthalate, and a content thereof is preferably from 0 to 30 parts by weight per 100 parts by weight of the binder resin.

Specific examples of the leveling agent include silicone oil such as dimethyl silicone oil and methylphenyl silicone oil; and polymers or oligomers having a perfluoroalkyl group in the side chain, and a content thereof is preferably from 0 to 1 part by weight per 100 parts by weight of the binder resin.

The photoreceptor of the present invention may include a protective layer on the photosensitive layer. The protective layer is a layer wherein a particulate metal or a particulate metallic oxide is dispersed in a binder resin. The binder resin preferably has transparency to visible light and infrared light, good electric insulation, good mechanical strength and good adhesiveness. Specific examples of the binder resin include ABS resins, ACS resins, olefin-vinyl monomer copolymers, polyether chloride, allyl resins, phenolic resins, polyacetal, polyamide, polyamideimide, polyacrylate, polyallylsulfone, polybutylene, polybutyleneterephthalate, polycarbonate, polyethersulfone, polyethylene, polyethyleneterephthalate, polyimide, acrylic resins, polymethylpentene, polypropylene, polyphenylene oxide, polysulfone, polystyrene, AS resins, butadiene-styrene copolymers, polyurethane, polyvinylchloride, polyvinylidene chloride, epoxy resins, etc. Specific examples of the metal oxide include titanium oxide, tin oxide, kalium titanate, TiO, TiN, zinc oxide, indium oxide, antimony oxide, etc.

The protective layer may include fluorine-containing resins such as polytetrafluoroethylene and silicone resins, and these resins wherein an inorganic materials such as metals, metal oxides and ceramics. The protective layer can be formed by conventional coating methods, and preferably has a thickness of from 0.1 to 10 μm.

Specific examples of solvents for use in preparing the photoreceptor of the present invention include chlorinated solvents such as dichloromethane, tetrahydrofuran, dioxane, toluene, cyclohexanone, methyl ethyl ketone and acetone. Particularly, the chlorinated solvents such as dichloromethane have preferably been used to prepare photoreceptors because of dissolving resins and dispersing pigments well, and having a low boiling point and no ignitability. However, the chlorinated solvents are restrictedly used for the purpose of environmental protection and the photoreceptors can be prepared only in a period when the chlorinated solvents are permitted to use. Therefore, the method of storing photoreceptors and process cartridges of the present invention is essential.

The process cartridge of the present invention includes a photoconductive photoreceptor; and at least one of a charger, an irradiator, an image developer, a transferer, a cleaner and a discharger. The process cartridge is detachable from an image forming apparatus, and makes maintenance thereof such as a part replacement and repair easier.

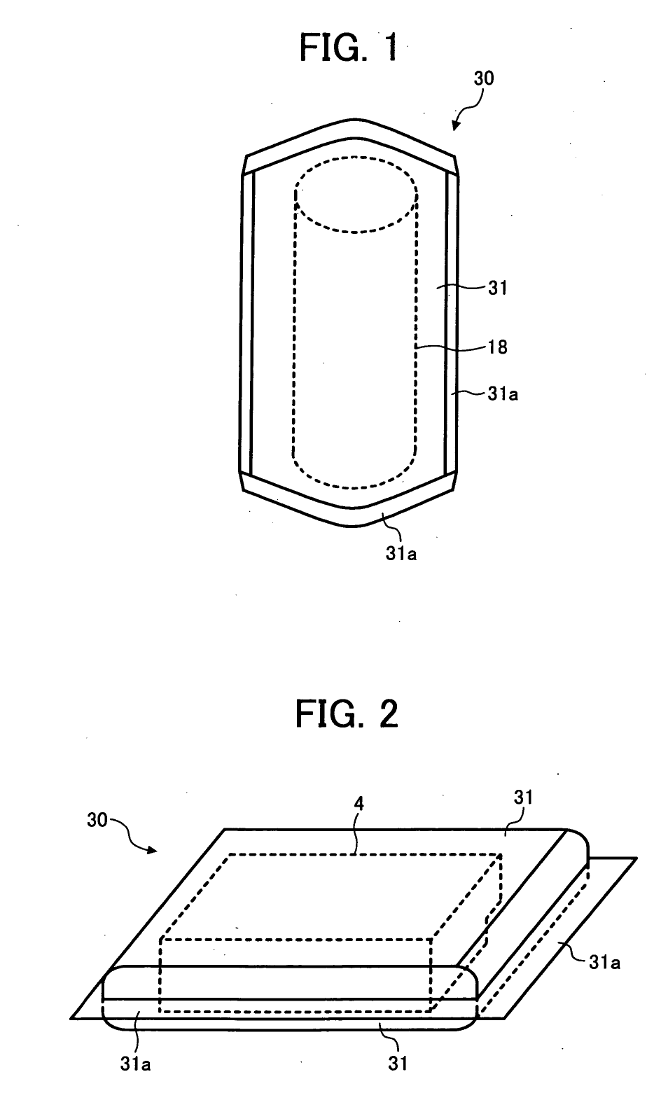

FIG. 1 is an oblique perspective view illustrating an embodiment of the storage member of the present invention.

As shown in FIG. 1, a photoreceptor drum 18 detachable from an image forming apparatus is sealed in a storage member 30 when store after produced (for long periods). The storage member 30 is formed of two generally rectangular polyolefin films 31, the four sides of which (31a) are heat-sealed.

Specifically, three sides of the two polyolefin films 31 are heat-sealed first to make the storage member 30 pouched. Then, after the photoreceptor drum 18 is put in the storage member 30 through an opening (a not heat-sealed side) thereof, the opening is heat-sealed.

Just one polyolefin film 31 can form the pouched storage member 30. Specifically, one polyolefin film 31 is folded in half and two sides thereof are heat-sealed. Then, after the photoreceptor drum 18 is put in the pouched storage member 30 through an opening (a not heat-sealed side) thereof, the opening is heat-sealed.

The polyolefin films can be sealed with each other by ultrasonic welding as well as the heat-sealing.

In addition, a belt-shaped photoreceptor belt can be sealed in the storage member 30 as well as the drum-shaped photoreceptor drum 18.

The photoreceptor belt often exposes its cut sectional side. Therefore, a moisture infiltrates through the sectional side to separate the photosensitive layer from the belt, resulting in deterioration of durability and sensitivity of the photoreceptor. Aluminum is laminated on the polyolefin film 31 to prevent a moisture from penetrating through the film to the photoreceptor belt. In addition, plural photoreceptors can be stored in the storage member 30, and the photoreceptor may be stored with a tray or a box therein.

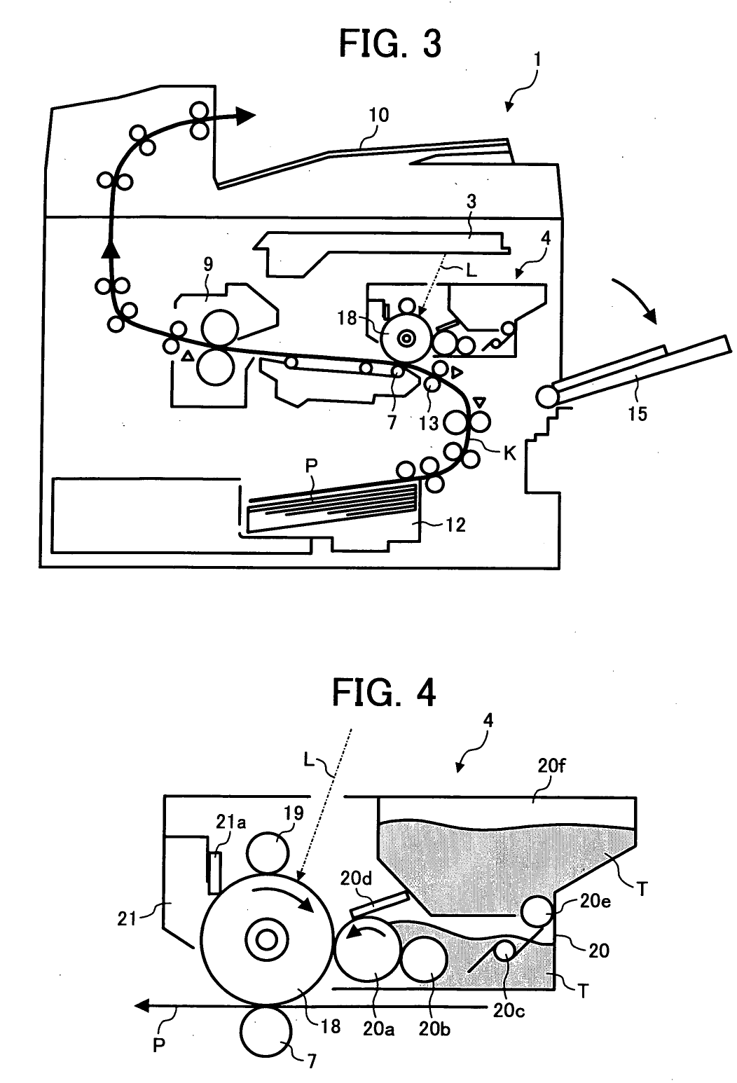

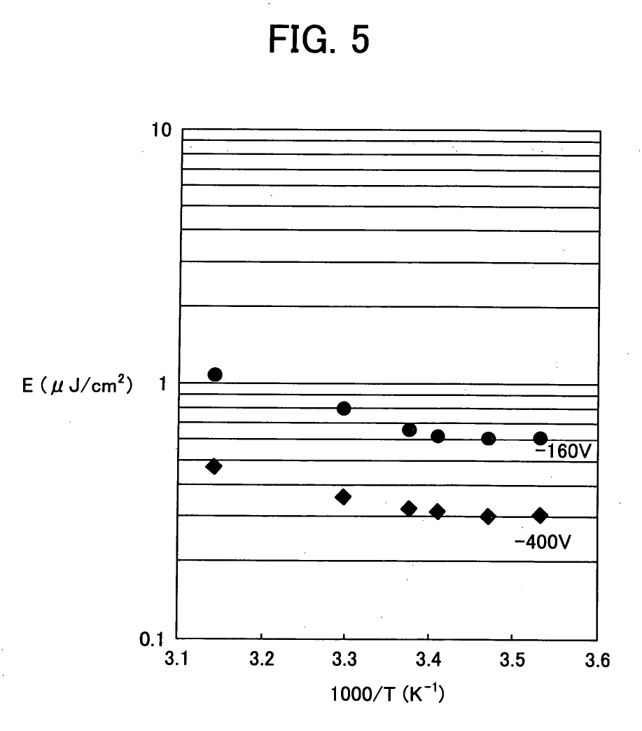

FIG. 2 is an oblique perspective view illustrating another embodiment of the storage member storing a process cartridge of the present invention. FIG. 3 is a schematic perspective view illustrating an image forming apparatus including the process cartridge detachable therefrom. FIG. 4 is a cross-sectional view illustrating the process cartridge.

The storage member 30 in FIG. 2 seals and stores a process cartridge 4 including the photoreceptor drum 18.

As shown in FIG. 2, the storage member 30 is formed of two generally rectangular polyolefin films 31, the four sides of which (31a) are heat-sealed as well as the storage member 30 in FIG. 1.

Specifically, three sides of the two polyolefin films 31 are heat-sealed first to make the storage member 30 pouched. Then, after the process cartridge 4 is put in the storage member 30 through an opening (a not heat-sealed side) thereof, the opening is heat-sealed.

In FIG. 3, numeral 1 is a laser printer as an image forming apparatus, 3 is an irradiator irradiating a photoreceptor drum 18 with imagewise light L based on image information, 4 is a process cartridge detachable from the apparatus 1, 7 is a transferer transferring a toner image formed on the photoreceptor drum 18 onto a recording medium P, 9 is a fixer fixing the toner image thereon, 10 is a discharge tray receiving an output image, 12 is paper feeder containing the recording medium P such as a transfer paper, 13 is a resist roller transporting the recording medium P to the transferer 7 and 15 is a door opening and closing when the process cartridge 4 is put out of or in the apparatus. First, the imagewise light L based on image information is irradiated onto the photoreceptor drum 18 in the process cartridge 4 from the irradiator 3. The irradiator 3 forms an electrostatic latent image on the photoreceptor drum 18 by a multilevel writing method.

The photoreceptor drum 18 rotates clockwise, and through specified image forming processes such as a charging process, an irradiating process and a developing process, a toner image is formed thereon according to the image information. Then, the toner image formed on the photoreceptor drum 18 is transferred onto the recording medium P transported by the resist roller 13.

Meanwhile, the uppermost recording medium P contained in the paper feeder 12 transported toward a transport route K. Then, the recording medium P passes the transport route K and reaches the resist roller 13. The recording medium P is transported to the transferer 7 in exact timing with the toner image formed on the photoreceptor drum 18 such that positioning of the toner image fits the recording medium P.

The recording medium P reaches the fixer 9 through a transport route after passing the transferer 7. The recording medium P is transported between a fixing roller and pressure roller, and the toner image is fixed thereon with a heat from the fixing roller and a pressure from the pressure roller. Then, the recording medium P the toner image is fixed on is discharged from the apparatus 1 as an output image, and is placed on the discharge tray 10.

Thus, a series of image forming processes is completed. As shown in FIG. 4, the process cartridge 4 includes the photoreceptor drum 18 as a photoreceptor, a charger 19, an image developer 20 and a cleaner 21 in a body, and is detachable from the image forming apparatus 1. This improves maintenance of the image forming units.

A driven gear is located on a side of a rotating shaft of the photoreceptor drum 18. The driven gear transmits a driving force from a driving motor (not shown) of the apparatus 1 to rotating members such as the photoreceptor drum 18, a developing roller 20a and a feeding roller 20b.

The charger 19 has the shape of a roller formed of an electroconductive material including a stainless shaft and a resin wherein an electroconductive powder is dispersed. The cleaner 21 includes a cleaning blade 21a formed of a rubber material, removing an untransferred toner from the photoreceptor drum 18 while contacting thereto.

The image developer 20 typically includes a developing roller 20a facing the photoreceptor drum 18, a feeding roller 20b frictionizing the developing roller 20a, a stirring member 20c stirring and transporting a toner in the image developer 20, a doctor blade 20d contacting the developing roller 20a, and a toner container 20f containing the toner T fed by a toner feeding roller 20e.

The photoreceptor drum 18 rotates clockwise in FIG. 4, and a surface thereof is charged to have a desired charge potential at a position facing the charger 19 (a charging process). Then, the surface thereof reaches an position wherein imagewise light L is irradiated thereto, and an electrostatic latent image is formed thereon according to the image information while receiving the imagewise light L in the scanning direction thereof (a direction perpendicular to a paper face).

Then, the surface of the photoreceptor drum 18 the latent image is formed on reaches a position facing the image developer 20, which develops the latent image formed thereon o form a toner image.

The developing roller 20a rotates in a direction indicated by an arrow. The toner T in the image developer 20 is stirred and transported by the stirring member 20c, and reaches the feeding roller 20b. The toner T reaching the feeding roller 20b is transported to a contact position thereof to the developing roller 20a, where the toner T is frictionized and charged. The frictionized and charged toner T borne by the developing roller 20a is thinned at a position of doctor blade 20d, and reaches a position facing of the photoreceptor drum 18. Then, the toner T on the developing roller 20a adheres to the latent image on the photoreceptor drum 18.

The toner t contained in the toner container 20f is timely provided in the image developer 20 through a rotation of the toner feeding roller 20e with the consumption of the toner T therein.

Then, the surface of the photoreceptor drum 18 the toner image is formed on reaches a position facing the transferer 7, and the toner image thereon is transferred on to a recording medium P transported to the transferer 7. An untransferred toner to the recording medium P is slightly remains on the photoreceptor drum 18.

Then, the surface of the photoreceptor drum 18 the untransferred toner adheres to reaches the cleaning blade 21a. The cleaning blade 21a contacting the photoreceptor drum 18 removes the untransferred toner thereon from the surface thereof. The untransferred toner removed therefrom is collected in a collection space of the cleaner 21. Then, the surface of the photoreceptor drum 18 reaches a position wherein discharging light emitted from a discharger (not shown) is irradiated thereto. Then, the surface potential of the photoreceptor drum 18 is initialized, receiving the discharging light. Thus, a series of image forming processes performed on the photoreceptor drum 18 is completed.

As mentioned above, the image forming apparatus the process cartridge 4 stored in the storage member 30 is installed includes a an irradiator 3 using a multilevel writing method. When the writing method is binary, or more or less binary, the photoreceptor scarcely produces poor images unless sensitivity thereof largely varies. The multilevel writing method can faithfully reproduce halftone images such as photo images. However, when the photoreceptor deteriorates in its sensitivity, the resultant images have unnatural colors. Therefore, the process cartridge of the present invention is more effectively used for the image forming apparatus using the multilevel writing method.

Having generally described this invention, further understanding can be obtained by reference to certain specific examples, which are provided herein for the purpose of illustration only and are not intended to be limiting. In the descriptions in the following examples, the numbers represent weight ratios in parts, unless otherwise specified.

### EXAMPLES

### Examples 1 to 4 and Comparative Examples 1 and 2

The following materials were mixed in a ball mill pot using an alumina ball having a diameter of 10 mm for 72 hrs to prepare a milled liquid.

| | |
|---|---|
| Titanium oxide | 50.0 |
| (CR-60 from ISHIHARA SANGYO KAISHA, LTD.) | |
| Alkyd resin | 15.0 |
| (Bekkolite M6401-50 from Dainippon Ink And Chemicals, Inc.) | |
| Melamine resin | 10.0 |
| (Super BekkaminL-121-60 from Dainippon Ink And | |
| Chemicals, Inc.) | |
| Methyl ethyl ketone (from KANTOU KAGAKU) | 31.7 |

105.0 parts of cyclohexanone (from KANTOU KAGAKU) were added to the milled liquid, and the liquid is further milled for 2 hrs to prepare an undercoat layer coating liquid. A nickel seamless belt (having a Vickers hardness of from 480 to 510 and a purity not less than 99.2%) having a peripheral length of 290.3 mm and a thickness of 30 μm was dipped in the undercoat layer coating liquid, and the dipped nickel seamless belt was dried at 135° C. for 25 min to form an undercoat layer having a thickness of 6.0 μm thereon.

The following materials were mixed in a ball mill pot using an agate ball having a diameter of 10 mm for 72 hrs to prepare a milled liquid.

| | |
|---|---|
| Charge generation material from Ricoh Company, Ltd. having the following formula (1): | 1.5 |

| | |
|---|---|
| 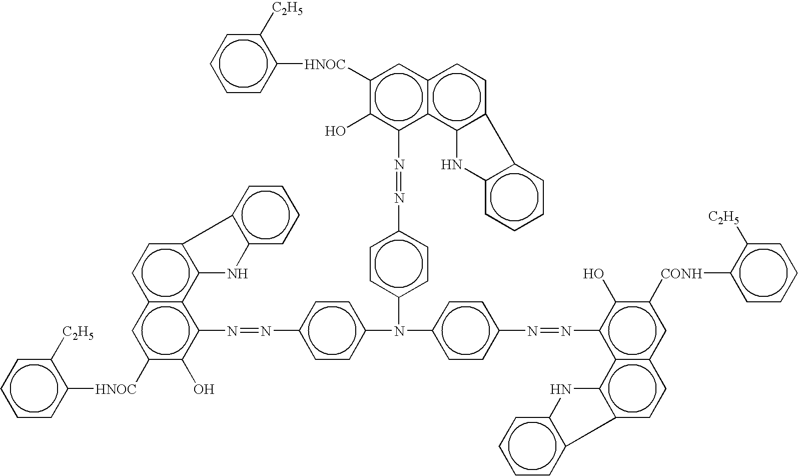 | (1) |

| | |
|---|---|
| Charge generation material from Ricoh Company, Ltd. having the following formula (2): | 1.5 |

| | |
|---|---|
| 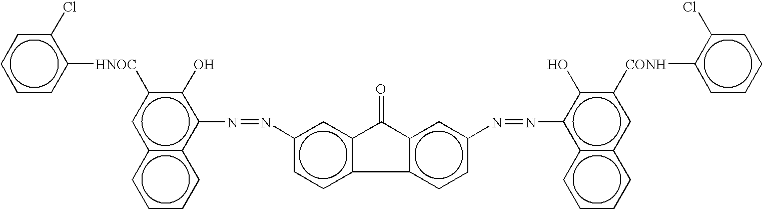 | (2) |

| | |
|---|---|
| Polyvinylbutyral resin (S-LEC BLS from Sekisui Chemical Co., Ltd.) | 1.0 |
| Cyclohexanone (from KANTOU KAGAKU) | 80.0 |

Further, 78.4 parts of cyclohexanone and 237.6 parts of methyl ethyl ketone were added to the milled liquid to prepare a charge generation layer coating liquid. The nickel seamless belt the undercoat layer was coated on was dipped therein, and the dipped nickel seamless belt was dried at 130° C. for 20 min to form a charge generation layer having a thickness of 0.12 μm thereon.

Next, a charge transport layer coating liquid including the following constituents was prepared.

| | |
|---|---|
| Charge transport material | 7 |
| from Ricoh Company, Ltd. having the following formula (3): | |
| 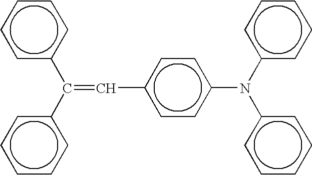 | (3) |
| Polycarbonate resin | 10 |
| (C-1400 from TEIJIN CHEMICALS LTD.) | |
| Silicone oil | 0.002 |
| (KF-50 from Shin-Etsu Chemical Co., Ltd.) | |
| Dichloromethane (KANTOU KAGAKU) | 830 |

The charge transport layer coating liquid was spray-coated on the nickel seamless belt the undercoat layer and charge generation layer were coated on while rotated, and the spray-coated nickel seamless belt was dried at 140° C. for 30 min to form a charge transport layer having a thickness of 25 μm thereon.

Both sides of the thus prepared photoreceptor belt were cut such that the photoreceptor belt had a width of 367 mm. In addition, a 50 mm×60 mm piece thereof was prepared as a sample for measuring electrostatic properties thereof.

The photoreceptors and samples for measuring electrostatic properties thereof were stored at 23, 20, 15 and 10° C. as Examples 1 to 4, and at 45 and 30° C. as Comparative Examples 1 and 2 for 2.5 years, respectively. After stored, sensitivities of the photoreceptors and samples were measured with a measurer for electrostatic properties EPA-8100 from Kawaguchi Electric Works, Co., Ltd. at 25° C. The photoreceptors and samples stored at 15 and 10° C. gradually had a temperature of 25° C. for 2 hrs after stored.

An irradiation quantity until a surface potential of the photoreceptor is reduced to −400 V and −160 V after charged to have a potential of −800 V and irradiated with light having a wavelength of 780 nm were measured to determine a sensitivity thereof. In FIG. 5, the horizontal axis is an inverse number of a storage temperature at an absolute temperature and the vertical axis is a logarithm of the sensitivity. The sensitivities of the photoreceptors stored at a temperature higher than 23° C. in Comparative Examples 1 and 2 linearly varied. The sensitivities of the photoreceptors stored at a temperature not higher than 23° C. in Examples 1 to 4 scarcely varied.

### Examples 5 and 6 and Comparative Example 3

The photoreceptors prepared in Examples 1 to 4 and Comparative Examples 1 and 2 stored at 23 and 10° C., and at 30° C. for 2.5 years were installed in an image forming apparatus IPSiO Color 5100 using a multilevel writing method from Ricoh Company, Ltd. to produce images as Examples 5 and 6, and Comparative Example 3, respectively. An advertising image including a portrait photographed by a digital still camera produced by the photoreceptor stored at 30° C. in Example 3 had slightly a low image density in whole and unnatural colors. Those produced by the photoreceptors stored at 23 and 10° C. in Examples 5 and 6 were high-quality images. The image forming apparatus using the photoreceptors stored at 23 and 10° C. in Examples 5 and 6 produced high-quality 2,000 A4 images without deterioration of image density.

### Example 7

The photoreceptor prepared in any one of Examples 1 to 4 was covered with a layered film including polyester, aluminum and polyethylene, and which was heat-sealed to seal in the photoreceptor. The aluminum and polyethylene were dry-laminated. The sealed-in photoreceptor was stored at −10° C. for 26 months. The sealed-in photoreceptor left for 5 hrs at a room temperature after stored produced high-quality images similarly to that of Example 5.

### Comparative Example 4

The procedure of sealing in the photoreceptor in Example 7 was repeated to seal in the photoreceptor except that the aluminum and polyethylene were laminated with a polyurethane adhesive. The sealed-in photoreceptor was stored at 28° C. for 11 months. The sealed-in photoreceptor after stored produced images having slightly a low image density and slightly an unnatural color when the images were produced in the same method as that of Example 5.

### Example 8

An aluminum drum was cut with a diamond cutting tool to have a diameter of 90 mm, a length of 352 mm and a thickness of 2.5 mm.

15 parts of an acrylic resin (ACRYDIC A-460-60 from Dainippon Ink And Chemicals, Inc.) and 10 parts of a melamine resin (Super Bekkamin L-121-60 from Dainippon InkAnd Chemicals, Inc.) were dissolved in 80 parts of methyl ethyl ketone to prepare a solution. 90 parts of titanium oxide powder (TM-1 from Fuji Titanium Industry Co., Ltd.) were added thereto and dispersed therein with a ball mill for 72 hrs to prepare an undercoat layer coating liquid. The aluminum drum having a rough surface was dipped therein and vertically pulled up at a constant speed.

The aluminum drum was dried at 140° C. for 20 min in a drying chamber while a direction thereof is maintained to form an undercoat layer having a thickness of 2.0 μm thereon.

Next, 15 parts of a butyral resin (S-LEC BLS from Sekisui Chemical Co., Ltd.) were dissolved in 150 parts of cyclohexanone to prepare a solution, and 10 parts of a tris azo pigment having the following formula (1) were added thereto and dispersed in a ball mill for 60 hrs.

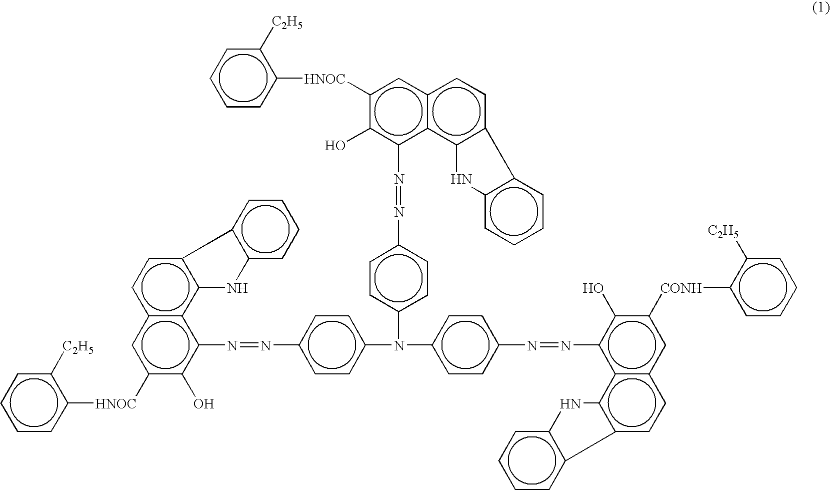

Further, 210 parts of cyclohexanone were added thereto and dispersed for 5 hrs, and the dispersed mixture was diluted with cyclohexanone while stirred to have a solid content of 1.5% by weight. The aluminum drum the undercoat layer is formed on was dipped in the thus prepared charge generation layer coating liquid, and pulled up at a constant speed. The dipped aluminum drum the undercoat layer is formed on was dried at 120° C. for 20 min similarly to forming the undercoat layer to form a charge generation layer having a thickness of 0.2 μm thereon.

Further 6 parts of a charge transport material having the following formula (4), 10 parts of a polycarbonate resin (Panlite K-1300 from TEIJIN CHEMICALS LTD.) and 0.002 parts of a silicone oil (KF-50 from Shin-Etsu Chemical Co., Ltd.) were dissolved in 90 parts of methylene chloride to prepare a charge transport layer coating liquid.

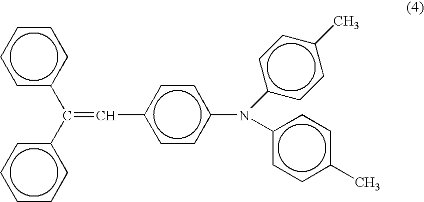

The aluminum drum the undercoat layer and charge generation layer are formed on was dipped in the thus prepared charge transport layer coating liquid, and pulled up at a constant speed. The dipped aluminum drum was dried at 120° C. for 20 min similarly to forming the undercoat layer to form a charge transport layer having a thickness of 23 μm on the charge generation layer.

The thus prepared photoreceptor was covered with a layered film including nylon (registered mark), aluminum and an ionomer resin, and which was heat-sealed to seal in the photoreceptor. The aluminum and ionomer resin were insolvent-laminated.

The sealed-in photoreceptor was stored at 10° C. for 3 years. The sealed-in photoreceptor left for 4 hrs at a room temperature after stored produced a high-quality image of a test chart of a portrait snap picture and a landscape picture through an image forming apparatus imagio color 2800 using a multilevel writing method from Ricoh Company, Ltd. High-quality 1,200 images without deterioration of image density were produced thereby.

### Examples 9 and 10, and Comparative Example 5

The following materials were mixed in a ball mill pot using an alumina ball having a diameter of 10 mm for 72 hrs to prepare a milled liquid.

| | |
|---|---|
| Titanium oxide | 50.0 |
| (CR-60 from ISHIHARA SANGYO KAISHA, LTD.) | |
| Alkyd resin | 15.0 |
| (Bekkolite M6401-50 from Dainippon Ink And Chemicals, Inc.) | |
| Melamine resin | 10.0 |
| (Super BekkaminL-121-60 from Dainippon Ink And | |
| Chemicals, Inc.) | |
| Methyl ethyl ketone (from KANTOU KAGAKU) | 31.7 |

105.0 parts of cyclohexanone (from KANTOU KAGAKU) were added to the milled liquid, and the liquid is further milled for 2 hrs to prepare an undercoat layer coating liquid. A nickel seamless belt (having a Vickers hardness of from 480 to 510 and a purity not less than 99.2%) having a peripheral length of 290.3 mm and a thickness of 30 μm was dipped in the undercoat layer coating liquid, and the dipped nickel seamless belt was dried at 135° C. for 25 min to form an undercoat layer having a thickness of 5.4 μm thereon.

The following materials were mixed in a ball mill pot using an agate ball having a diameter of 10 mm for 72 hrs to prepare a milled liquid.

| | |
|---|---|
| Charge generation material from Ricoh Company, Ltd. having the following formula (1): | 1.5 |

| | |
|---|---|
| 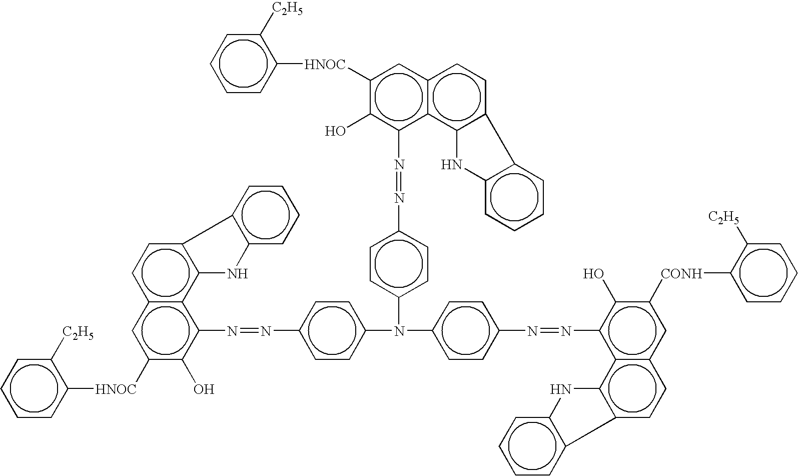 | (1) |

| | |
|---|---|
| Charge generation material from Ricoh Company, Ltd. having the following formula (2): | 1.5 |

| | |
|---|---|
| 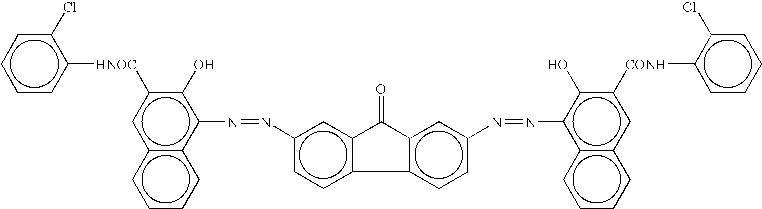 | (2) |

| | |
|---|---|
| Polyvinylbutyral resin (S-LEC BLS from Sekisui Chemical Co., Ltd.) | 1.0 |
| Cyclohexanone (from KANTOU KAGAKU) | 80.0 |

Further, 78.4 parts of cyclohexanone and 237.6 parts of methyl ethyl ketone were added to the milled liquid to prepare a charge generation layer coating liquid. The nickel seamless belt the undercoat layer was coated on was dipped therein, and the dipped nickel seamless belt was dried at 130° C. for 20 min to form a charge generation layer having a thickness of 0.12 μm thereon.

Next, a charge transport layer coating liquid including the following constituents was prepared.

| | |
|---|---|
| Charge transport material | 7 |
| from Ricoh Company, Ltd. having the following formula (3): | |
| 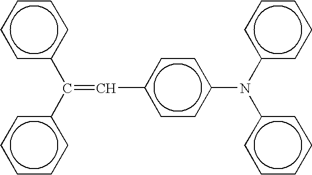 | (3) |
| Polycarbonate resin | 10 |
| (C-1400 from TEIJIN CHEMICALS LTD.) | |
| Silicone oil | 0.002 |
| (KF-50 from Shin-Etsu Chemical Co., Ltd.) | |
| Dichloromethane (KANTOU KAGAKU) | 830 |

The charge transport layer coating liquid was spray-coated on the nickel seamless belt the undercoat layer and charge generation layer were coated on while rotated, and the spray-coated nickel seamless belt was dried at 140° C. for 30 min to form a charge transport layer having a thickness of 26 μm thereon.

Three 50 mm×60 mm pieces were cut out from the thus prepared photoreceptor as samples for measuring electrostatic properties thereof. An aluminum film 9 μm thick and a polyethylene film 30 μm thick were laminated with a polyurethane adhesive having a thickness of about 3 μm to prepare a laminate film. The polyurethane adhesive was diluted with ethylacetate. The laminate film was heated and dried under reduced pressure on various conditions to prepare 3 storage members so as to have a total concentration of ethylacetate, acetic acid and ethanol of 11 ppm (Example 9), 85 ppm (Example 10) and 123 ppm (Comparative Example 5), respectively, wherein the above-mentioned photoreceptor samples were stored. The storage member was formed of 2 laminate films with the polyethylene film inside, the four sides of which were heat-sealed, and wherein the photoreceptor sample was sealed. Then, the sealed-in photoreceptor samples were stored at 38° C. and 90% RH for 14 days. After stored, sensitivities of the photoreceptors and samples were measured with a measurer for electrostatic properties EPA-8100 from Kawaguchi Electric Works, Co., Ltd. at 25° C. An irradiation quantity until a surface potential of the photoreceptor was reduced to −400V and −160 V after charged to have a potential of −800 V and irradiated with light having a wavelength of 780 nm were measured to determine a sensitivity thereof. The results are shown in Table 1.

The test results of Examples 9 and 10 and Comparative Example 5 shown in Table 1 prove that a specified total concentration or less of the ethylacetate, acetic acid and ethanol decreases sensitivity deterioration of photoreceptors even after stored at a high temperature for a short period.

Further, the above-mentioned test samples in Example 9 and Comparative Example 5 were repeatedly charged and irradiated 1,000 times a minute for 1.5 hrs such that a sample current of −5.6 μA passes through the sample when having a charge potential of −800 V. The irradiation quantity until a surface potential of the photoreceptor was reduced to −160 V after charged to have a potential of −800 V was 0.85 μJ/cm² and 1.49 μJ/cm² for the test samples in Example 9 and Comparative Example 5, respectively.

This proves that less total concentration of the ethylacetate, acetic acid and ethanol decreases sensitivity deterioration of photoreceptors as well.

### Example 11

An aluminum film 9 μm thick and a polyethylene film 30 μm thick were laminated with a polyurethane adhesive having a thickness of about 2.0 μm to prepare a laminate film. The polyurethane adhesive was diluted with ethylacetate. The laminate film was heated and dried under reduced pressure on various conditions to prepare a storage member. Further, a biaxially-stretched polyester film 12 μm thick was laminated on the aluminum film with the polyurethane adhesive diluted with ethylacetate. The laminate film was vacuum-heated to seal in the above-mentioned sample such that a total concentration of ethylacetate, acetic acid and ethanol in the adhesive layer on the polyethylene film and therein was 3 ppm. Another sample was stored without the storage member.

The storage member was formed of the 2 laminate films, the four sides of which were heat-sealed, and wherein the photoreceptor sample was sealed.

Then, the sealed-in photoreceptor samples were stored at 22° C. and 60% RH for 4 years. After stored, sensitivities of the photoreceptors and samples were measured by the same method in Examples 9 and 10.

TABLE 1

| | Concentration | Irradiation | Irradiation |
|---|---|---|---|
| | of organic | quantity to | quantity to |
| | solvent (ppm) | −400 V (μJ/cm²) | −160 V (μJ/cm²) |
| Example 9 | 11 | 0.33 | 0.71 |
| Example 10 | 85 | 0.34 | 0.75 |
| Example 11 | 3 | 0.35 | 0.75 |
| Comparative | 123 | 0.36 | 0.82 |
| Example 5 | | | |

The test results of Example 11 prove that a specified total concentration or less of the ethylacetate, acetic acid and ethanol decreases sensitivity deterioration of photoreceptors stored at a pertinent temperature even after stored for long periods, i.e., not less than an year.

### Example 12

The photoreceptor belt prepared in Example 9 and 10, which was cut to have a width of 367 mm, was stored in the storage member prepared in Example 11 so as to have a total concentration of ethylacetate, acetic acid and ethanol of 18 ppm. The storage member was formed of the 2 laminate films with the polyethylene film inside, the four sides of which were heat-sealed, and wherein the photoreceptor belt was sealed. Then, the sealed-in photoreceptor belt was stored at 8° C. for 4 years.

The photoreceptor belt after stored installed in an image forming apparatus IPSiO Color 5100 using a multilevel writing method from Ricoh Company, Ltd. produced a high-quality image including a portrait photographed by a digital camera. Further, the image forming apparatus using the photoreceptor belt produced high-quality 2,000 A4 images without deterioration of image density.

The test results of Example 12 prove that a specified total concentration or less of the ethylacetate, acetic acid and ethanol decreases sensitivity deterioration of photoreceptors stored at a pertinent temperature even after stored for long periods, i.e., not less than an year, and that sufficient quality thereof can be maintained as replacement parts for image forming apparatus.

### Example 13

An aluminum drum was cut with a diamond cutting tool to have a diameter of 90 mm, a length of 352 mm and a thickness of 2.5 mm.

15 parts of an acrylic resin (ACRYDIC A-460-60 from Dainippon Ink And Chemicals, Inc.) and 10 parts of a melamine resin (Super Bekkamin L-121-60 from Dainippon Ink And Chemicals, Inc.) were dissolved in 80 parts of methyl ethyl ketone to prepare a solution. 90 parts of titanium oxide powder (TM-1 from Fuji Titanium Industry Co., Ltd.) were added thereto and dispersed therein with a ball mill for 72 hrs to prepare an undercoat layer coating liquid.

Next, the aluminum drum having a rough surface was dipped therein and vertically pulled up at a constant speed. The aluminum drum was dried at 140° C. for 20 min in a drying chamber while a direction thereof is maintained to form an undercoat layer having a thickness of 2.0 μm thereon.

Next, 15 parts of a butyral resin (S-LEC BLS from Sekisui Chemical Co., Ltd.) were dissolved in 150 parts of cyclohexanone to prepare a solution, and 10 parts of a tris azo pigment having the following formula (1) were added thereto and dispersed in a ball mill for 60 hrs.

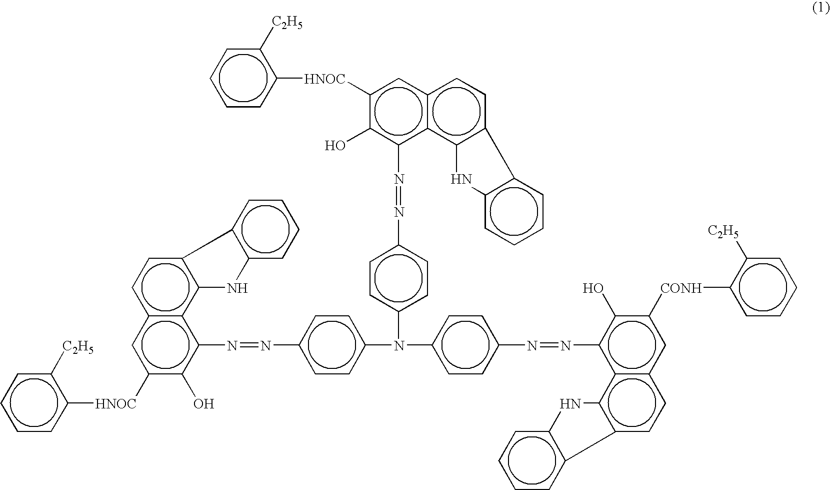

Further, 210 parts of cyclohexanone were added thereto and dispersed for 5 hrs, and the dispersed mixture was diluted with cyclohexanone while stirred to have a solid content of 1.5% by weight. The aluminum drum the undercoat layer is formed on was dipped in the thus prepared charge generation layer coating liquid, and pulled up at a constant speed. The dipped aluminum drum the undercoat layer is formed on was dried at 120° C. for 20 min similarly to forming the undercoat layer to form a charge generation layer having a thickness of 0.2 μm thereon.

Further 6 parts of a charge transport material having the following formula (4), 10 parts of a polycarbonate resin (Panlite K-1300 from TEIJIN CHEMICALS LTD.) and 0.002 parts of a silicone oil (KF-50 from Shin-Etsu Chemical Co., Ltd.) were dissolved in 90 parts of methylene chloride to prepare a charge transport layer coating liquid.

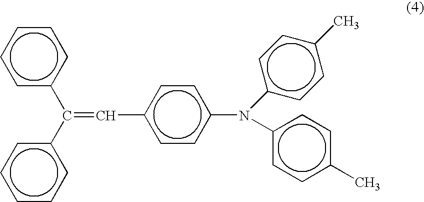

The aluminum drum the undercoat layer and charge generation layer are formed on was dipped in the thus prepared charge transport layer coating liquid, and pulled up at a constant speed. The dipped aluminum drum was dried at 120° C. for 20 min similarly to forming the undercoat layer to form a charge transport layer having a thickness of 23 μm on the charge generation layer.

The thus prepared photoreceptor drum was stored in the storage member prepared in Example 11 so as to have a total concentration of ethylacetate, acetic acid and ethanol of 2 ppm. The storage member was formed of the 2 laminate films with the polyethylene film inside, the four sides of which were heat-sealed, and wherein the photoreceptor belt was sealed. However, the aluminium film was dry-laminated on the polyethylene film.

Then, the sealed-in photoreceptor was stored at 10° C. for 2 years. The sealed-in photoreceptor left for 4 hrs at a room temperature after stored produced a high-quality image of a test chart of a portrait snap picture and a landscape picture through an image forming apparatus imagio color 2800 using a multilevel writing method from Ricoh Company, Ltd. High-quality 1,200 images without deterioration of image density were produced thereby.

The test results of Example 13 prove that a specified total concentration or less of the ethylacetate, acetic acid and ethanol decreases sensitivity deterioration of photoreceptors stored at a pertinent temperature without an influence of dew condensation due to a difference of temperature even after stored for long periods, i.e., not less than an year, and that sufficient quality thereof can be maintained as replacement parts for image forming apparatus.

(1) Preparation of Polyolefin Laminate Film 1

A polyether adhesive was diluted with ethylacetate, and the diluted polyether adhesive was coated on an aluminum film 7 μm thick with a roll coater and dried to form an adhesive layer, on which a nylon film 20 μm thick was bonded upon application of pressure. A polyethylene film 15 μm thick was extrusion-coated on the other side of the aluminum film to form a polyolefin laminate film 1.

(2) Preparation of Polyolefin Laminate Film 2

The procedure for preparation of the polyolefin laminated film 1 was repeated except for replacing the nylon film with a polyester film to prepare a polyolefin laminate film 2.

(3) Preparation of Polyolefin Laminate Film 3

The procedure for preparation of the polyolefin laminated film 1 was repeated except for replacing the polyethylene film with a polypropylene film 14 μm thick to prepare a polyolefin laminate film 3.

(4) Preparation of Polyolefin Laminate Film 4

The procedure for preparation of the polyolefin laminated film 1 was repeated except that a polyether adhesive was diluted with ethylacetate, and the diluted polyether adhesive was coated on the other side of the aluminum film with a roll coater, on which a polyethylene film 12 μm thick was bonded upon application of pressure to prepare a polyolefin laminate film 4.

### Examples 14 to 15 and Comparative Example 6

The following materials were mixed in a ball mill pot using an alumina ball having a diameter of 10 mm for 72 hrs to prepare a milled liquid.

| | |
|---|---|
| Titanium oxide | 50.0 |
| (CR-60 from ISHIHARA SANGYO KAISHA, LTD.) | |
| Alkyd resin | 15.0 |
| (Bekkolite M6401-50 from Dainippon Ink And Chemicals, Inc.) | |
| Melamine resin | 10.0 |
| (Super BekkaminL-121-60 from Dainippon Ink And | |
| Chemicals, Inc.) | |
| Methyl ethyl ketone (from KANTOU KAGAKU) | 31.7 |

105.0 parts of cyclohexanone (from KANTOU KAGAKU) were added to the milled liquid, and the liquid is further milled for 2 hrs to prepare an undercoat layer coating liquid. A nickel seamless belt (having a Vickers hardness of from 480 to 510 and a purity not less than 99.2%) having a peripheral length of 290.3 mm and a thickness of 30 μm was dipped in the undercoat layer coating liquid, and the dipped nickel seamless belt was dried at 135° C. for 25 min to form an undercoat layer having a thickness of 6.0 μm thereon.

The following materials were mixed in a ball mill pot using an agate ball having a diameter of 10 mm for 72 hrs to prepare a milled liquid.

| | |
|---|---|
| Charge generation material from Ricoh Company, Ltd. having the following formula (1): | 1.5 |

| | |
|---|---|
| 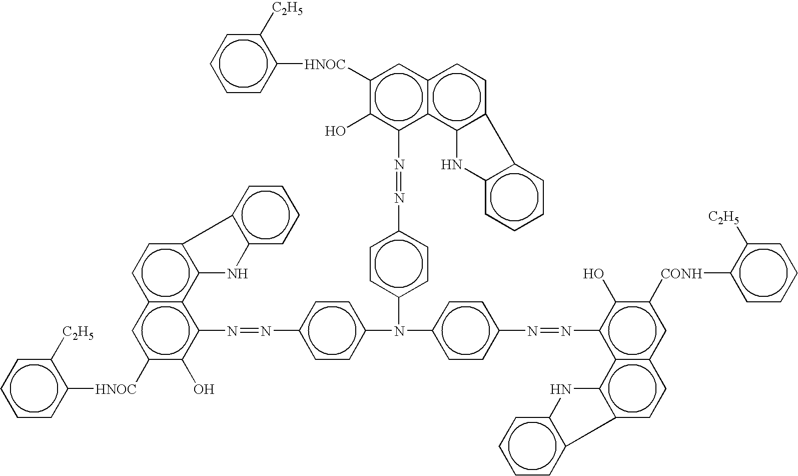 | (1) |

| | |
|---|---|
| Charge generation material from Ricoh Company, Ltd. having the following formula (2): | 1.5 |

| | |
|---|---|
| 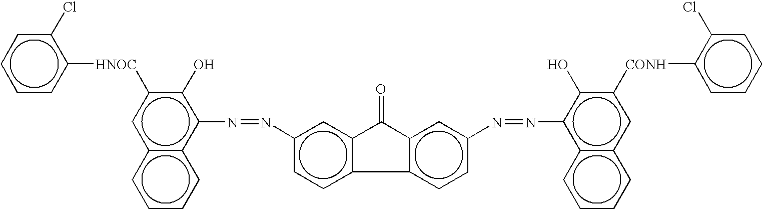 | (2) |

| | |
|---|---|
| Polyvinylbutyral resin (S-LEC BLS from Sekisui Chemical Co., Ltd.) | 1.0 |
| Cyclohexanone (from KANTOU KAGAKU) | 80.0 |

Further, 78.4 parts of cyclohexanone and 237.6 parts of methyl ethyl ketone were added to the milled liquid to prepare a charge generation layer coating liquid. The nickel seamless belt the undercoat layer was coated on was dipped therein, and the dipped nickel seamless belt was dried at 130° C. for 20 min to form a charge generation layer having a thickness of 0.12 μm thereon.

Next, a charge transport layer coating liquid including the following constituents was prepared.

| | |
|---|---|
| Charge transport material | 7 |
| from Ricoh Company, Ltd. having the following formula (3): | |
| 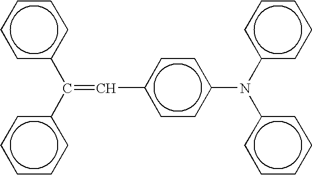 | (3) |
| Polycarbonate resin | 10 |
| (C-1400 from TEIJIN CHEMICALS LTD.) | |
| Silicone oil | 0.002 |
| (KF-50 from Shin-Etsu Chemical Co., Ltd.) | |
| Dichloromethane (KANTOU KAGAKU) | 830 |

The charge transport layer coating liquid was spray-coated on the nickel seamless belt the undercoat layer and charge generation layer were coated on while rotated, and the spray-coated nickel seamless belt was dried at 140° C. for 30 min to form a charge transport layer having a thickness of 22 μm thereon.

Both sides of the thus prepared photoreceptor belt were cut such that the photoreceptor belt had a width of 367 mm. In addition, a 50 mm×60 mm piece thereof was prepared as a sample for measuring electrostatic properties thereof.

The photoreceptors and samples for measuring electrostatic properties thereof were wrapped with the polyolefin laminate films 1, 2 and 4 respectively, which were heat-sealed to seal in the photoreceptors and samples.

Then, the sealed-in photoreceptors and samples were stored at 35±1° C. and 55% RH for 25 days. After stored, sensitivities of the photoreceptors and samples were measured with a measurer for electrostatic properties EPA-8100 from Kawaguchi Electric Works, Co., Ltd. at 25° C. An irradiation quantity until a surface potential of the photoreceptor is reduced to −400 V and −160 V after charged to have a potential of −800 V and irradiated with light having a wavelength of 780 nm were measured to determine a sensitivity thereof. The results are shown in Table 2.

TABLE 2

| | | Irradiation | Irradiation |
|---|---|---|---|
| | Polyolefin | quantity to | quantity to |
| | laminate film | −400 V (μJ/cm²) | −160 V (μJ/cm²) |
| Example 14 | 1 | 0.35 | 0.78 |
| Example 15 | 2 | 0.35 | 0.79 |
| Comparative | 4 | 0.41 | 0.99 |
| Example 6 | | | |

Further, the above-mentioned test samples in Example 14 and Comparative Example 6 were repeatedly charged and irradiated 1,000 times a minute for 2 hrs such that a sample current of −5.6 μA passes through the sample when having a charge potential of −800 V. The irradiation quantity until a surface potential of the photoreceptor was reduced to −160 V after charged to have a potential of −800 V was 0.89 μJ/cm² and 1.81 μJ/cm² for the test samples in Example 14 and Comparative Example 6, respectively.

### Examples 16 and 17

The photoreceptors were wrapped with the polyolefin laminate films 2 and 3 respectively, which were heat-sealed to seal in the photoreceptors. Then, the sealed-in photoreceptors were stored at 23±2° C. and 65% RH for 2 years and 10 months.

After stored, sensitivities of the photoreceptors were measured with a measurer for electrostatic properties EPA-8100 from Kawaguchi Electric Works, Co., Ltd. at 25° C. An irradiation quantity until a surface potential of the photoreceptor is reduced to −400 V and −160 V after charged to have a potential of −800 V and irradiated with light having a wavelength of 780 nm were measured to determine a sensitivity thereof. The results are shown in Table 3.

TABLE 3

| | | Irradiation | Irradiation |
|---|---|---|---|
| | Polyolefin | quantity to | quantity to |
| | laminate film | −400 V (μJ/cm²) | −160 V (μJ/cm²) |
| Example 16 | 2 | 0.35 | 0.77 |
| Example 17 | 3 | 0.35 | 0.75 |

### Example 18

The photoreceptor prepared in Example 14 was placed between two polyolefin laminate films 2, and the four sides of which were heat-sealed to seal in the photoreceptor. The sealed-in photoreceptor was stored at 10±1° C. for 4 years.

The photoreceptor belt after stored installed in an image forming apparatus IPSiO Color 5100 using a multilevel writing method from Ricoh Company, Ltd. produced sufficiently a high-quality image including a portrait photographed by a digital camera. Further, the image forming apparatus using the photoreceptor belt produced sufficiently high-quality 2,000 A4 images without deterioration of image density.

### Example 19

An aluminum drum was cut with a diamond cutting tool to have a diameter of 90 mm, a length of 352 mm and a thickness of 2.5 mm.

15 parts of an acrylic resin (ACRYDIC A-460-60 from Dainippon Ink And Chemicals, Inc.) and 10 parts of a melamine resin (Super Bekkamin L-121-60 from Dainippon Ink And Chemicals, Inc.) were dissolved in 80 parts of methyl ethyl ketone to prepare a solution. 90 parts of titanium oxide powder (TM-1 from Fuji Titanium Industry Co., Ltd.) were added thereto and dispersed therein with a ball mill for 72 hrs to prepare an undercoat layer coating liquid. The aluminum drum having a rough surface was dipped therein and vertically pulled up at a constant speed. The aluminum drum was dried at 140° C. for 20 min in a drying chamber while a direction thereof is maintained to form an undercoat layer having a thickness of 2.0 μm thereon.

Next, 15 parts of a butyral resin (S-LEC BLS from Sekisui Chemical Co., Ltd.) were dissolved in 150 parts of cyclohexanone to prepare a solution, and 10 parts of a tris azo pigment having the following formula (1) were added thereto and dispersed in a ball mill for 60 hrs.

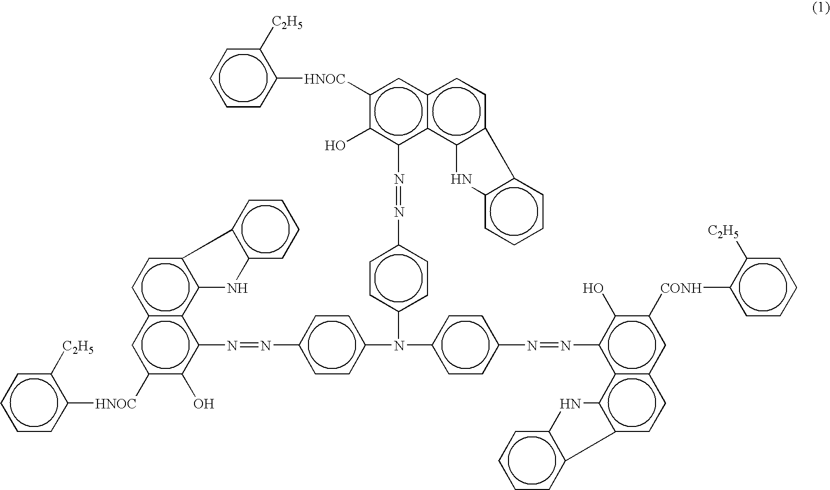

Further, 210 parts of cyclohexanone were added thereto and dispersed for 5 hrs, and the dispersed mixture was diluted with cyclohexanone while stirred to have a solid content of 1.5% by weight. The aluminum drum the undercoat layer is formed on was dipped in the thus prepared charge generation layer coating liquid, and pulled up at a constant speed. The dipped aluminum drum the undercoat layer is formed on was dried at 120° C. for 20 mm similarly to forming the undercoat layer to form a charge generation layer having a thickness of 0.2 μm thereon.

Further 6 parts of a charge transport material having the following formula (4), 10 parts of a polycarbonate resin (Panlite K-1300 from TEIJIN CHEMICALS LTD.) and 0.002 parts of a silicone oil (KF-50 from Shin-Etsu Chemical Co., Ltd.) were dissolved in 90 parts of methylene chloride to prepare a charge transport layer coating liquid.

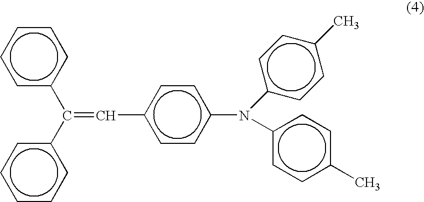

The aluminum drum the undercoat layer and charge generation layer are formed on was dipped in the thus prepared charge transport layer coating liquid, and pulled up at a constant speed. The dipped aluminum drum was dried at 120° C. for 20 min similarly to forming the undercoat layer to form a charge transport layer having a thickness of 23 μm on the charge generation layer.

The thus prepared photoreceptor was covered with the polyolefin laminate film 3, and which was heat-sealed to seal in the photoreceptor.

Then, the sealed-in photoreceptor was stored at 10° C. for 2 years. The sealed-in photoreceptor left for 4 hrs at a room temperature after stored produced sufficiently a high-quality image of a test chart of a portrait snap picture and a landscape picture through an image forming apparatus imagio color 2800 using a multilevel writing method from Ricoh Company, Ltd. Sufficiently high-quality 1,200 images without deterioration of image density were produced thereby.

(5) Preparation of Polyolefin Laminate Film 5

A polyether adhesive was diluted with ethylacetate, and the diluted polyether adhesive was coated on an aluminum film 7 μm thick with a roll coater and dried to form an adhesive layer, on which a nylon film 23 μm thick was bonded upon application of pressure. A melted polyester adhesive was coated on the other side of the aluminum film and a polyethylene film 12 μm thick was bonded thereon upon application of pressure to form a polyolefin laminate film 5.

(6) Preparation of Polyolefin Laminate Film 6

The procedure for preparation of the polyolefin laminated film 5 was repeated except for replacing the nylon film with a polyester film to prepare a polyolefin laminate film 6.

(7) Preparation of Polyolefin Laminate Film 7

The procedure for preparation of the polyolefin laminated film 5 was repeated except for coating a melted polyether adhesive on the other side of the aluminum film and bonding a polyethylene film 14 μm thick thereon upon application of pressure to prepare a polyolefin laminate film 7.

(8) Preparation of Polyolefin Laminate Film 8

The procedure for preparation of the polyolefin laminated film 5 was repeated except for coating a melted polyethylene on the other side of the aluminum film and bonding a polyethylene film 12 μm thick thereon upon application of pressure to prepare a polyolefin laminate film 8.

(9) Preparation of Polyolefin Laminate Film 9

The procedure for preparation of the polyolefin laminated film 5 was repeated except for coating a polyether adhesive diluted with ethylacetate on the other side of the aluminum film with a roll coater and bonding a polyethylene film 12 μm thick thereon upon application of pressure to prepare a polyolefin laminate film 9.

### Examples 20 and 21 and Comparative Example 7

The following materials were mixed in a ball mill pot using an alumina ball having a diameter of 10 mm for 72 hrs to prepare a milled liquid.

| | |
|---|---|
| Titanium oxide | 50.0 |
| (CR-60 from ISHIHARA SANGYO KAISHA, LTD.) | |
| Alkyd resin | 15.0 |
| (Bekkolite M6401-50 from Dainippon Ink And Chemicals, Inc.) | |
| Melamine resin | 10.0 |
| (Super BekkaminL-121-60 from Dainippon Ink And | |
| Chemicals, Inc.) | |
| Methyl ethyl ketone (from KANTOU KAGAKU) | 31.7 |

105.0 parts of cyclohexanone (from KANTOU KAGAKU) were added to the milled liquid, and the liquid is further milled for 2 hrs to prepare an undercoat layer coating liquid. A nickel seamless belt (having a Vickers hardness of from 480 to 510 and a purity not less than 99.2%) having a peripheral length of 290.3 mm and a thickness of 30 μm was dipped in the undercoat layer coating liquid, and the dipped nickel seamless belt was dried at 135° C. for 25 min to form an undercoat layer having a thickness of 6.0 μm thereon.

The following materials were mixed in a ball mill pot using an agate ball having a diameter of 10 mm for 72 hrs to prepare a milled liquid.

| | |
|---|---|
| Charge generation material from Ricoh Company, Ltd. having the following formula (1): | 1.5 |

| | |
|---|---|
| 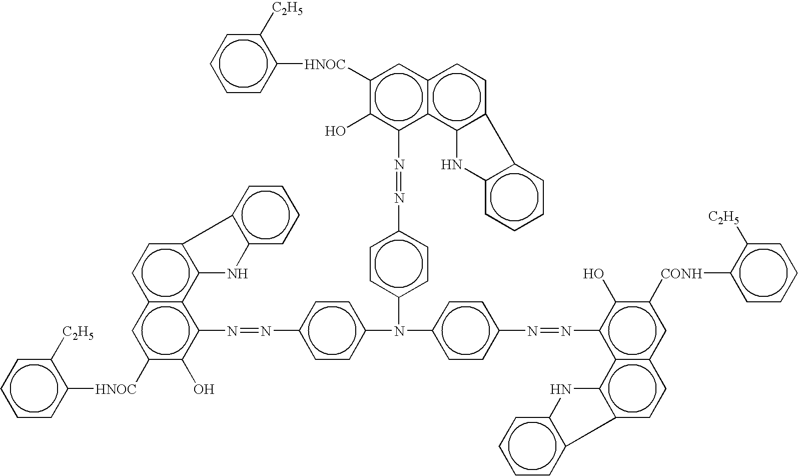 | (1) |

| | |
|---|---|
| Charge generation material from Ricoh Company, Ltd. having the following formula (2): | 1.5 |

| | |
|---|---|
| 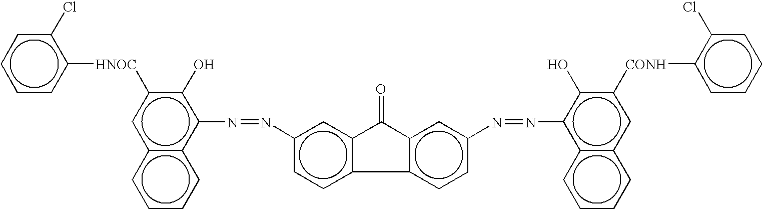 | (2) |

| | |
|---|---|
| Polyvinylbutyral resin (S-LEC BLS from Sekisui Chemical Co., Ltd.) | 1.0 |
| Cyclohexanone (from KANTOU KAGAKU) | 80.0 |

Further, 78.4 parts of cyclohexanone and 237.6 parts of methyl ethyl ketone were added to the milled liquid to prepare a charge generation layer coating liquid. The nickel seamless belt the undercoat layer was coated on was dipped therein, and the dipped nickel seamless belt was dried at 130° C. for 20 min to form a charge generation layer having a thickness of 0.12 μm thereon.

Next, a charge transport layer coating liquid including the following constituents was prepared.

| | |
|---|---|
| Charge transport material | 7 |
| from Ricoh Company, Ltd. having the following formula (3): | |
| 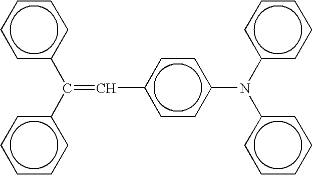 | (3) |
| Polycarbonate resin | 10 |
| (C-1400 from TEIJIN CHEMICALS LTD.) | |
| Silicone oil | 0.002 |
| (KF-50 from Shin-Etsu Chemical Co., Ltd.) | |
| Dichloromethane (KANTOU KAGAKU) | 830 |

The charge transport layer coating liquid was spray-coated on the nickel seamless belt the undercoat layer and charge generation layer were coated on while rotated, and the spray-coated nickel seamless belt was dried at 140° C. for 30 min to form a charge transport layer having a thickness of 25 μm thereon.

Both sides of the thus prepared photoreceptor belt were cut such that the photoreceptor belt had a width of 367 mm. In addition, a 50 mm×60 mm piece thereof was prepared as a sample for measuring electrostatic properties thereof.

The photoreceptors and samples for measuring electrostatic properties thereof were wrapped with the polyolefin laminate films 5, 6 and 9 respectively, which were heat-sealed to seal in the photoreceptors and samples.

Then, the sealed-in photoreceptors and samples were stored at 40° C. and 55% RH for 25 days. After stored, sensitivities of the photoreceptors and samples were measured with a measurer for electrostatic properties EPA-8100 from Kawaguchi Electric Works, Co., Ltd. at 25° C. An irradiation quantity until a surface potential of the photoreceptor is reduced to −400 V and −160 V after charged to have a potential of −800 V and irradiated with light having a wavelength of 780 nm were measured to determine a sensitivity thereof. The results are shown in Table 4.

TABLE 4

| | | Irradiation | Irradiation |
|---|---|---|---|
| | Polyolefin | quantity to | quantity to |
| | laminate film | −400 V (μJ/cm²) | −160 V (μJ/cm²) |
| Example 20 | 5 | 0.34 | 0.74 |
| Example 21 | 6 | 0.33 | 0.73 |
| Comparative | 9 | 0.37 | 0.95 |
| Example 7 | | | |

Further, the above-mentioned test samples in Example 20 and Comparative Example 7 were repeatedly charged and irradiated 1,000 times a minute for 2 hrs such that a sample current of −5.6 μA passes through the sample when having a charge potential of −800 V. The irradiation quantity until a surface potential of the photoreceptor was reduced to −160 V after charged to have a potential of −800 V was 0.86 μJ/cm and 1.59 μJ/cm² for the test samples in Example 20 and Comparative Example 7, respectively.

### Examples 22 and 23

The photoreceptors prepared in Example 20 were wrapped with the polyolefin laminate films 7 and 8 respectively, which were heat-sealed to seal in the photoreceptors. Then, the sealed-in photoreceptors were stored at 23±2° C. and 65% RH for 2 years and 10 months.

After stored, sensitivities of the photoreceptors were measured with a measurer for electrostatic properties EPA-8100 from Kawaguchi Electric Works, Co., Ltd. at 25° C. An irradiation quantity until a surface potential of the photoreceptor is reduced to −400 V and −160 V after charged to have a potential of −800 V and irradiated with light having a wavelength of 780 nm were measured to determine a sensitivity thereof. The results are shown in Table 5.

TABLE 5

| | | Irradiation | Irradiation |
|---|---|---|---|
| | Polyolefin | quantity to | quantity to |
| | laminate film | −400 V (μJ/cm²) | −160 V (μJ/cm²) |
| Example 22 | 7 | 0.34 | 0.75 |
| Example 23 | 8 | 0.34 | 0.73 |

### Example 24

The photoreceptor prepared in Example 20 was placed between two polyolefin laminate films 2, and the four sides of which were heat-sealed to seal in the photoreceptor. The sealed-in photoreceptor was stored at 10±1° C. for 4 years.

The photoreceptor belt after stored installed in an image forming apparatus IPSiO Color 5100 using a multilevel writing method from Ricoh Company, Ltd. produced a high-quality image including a portrait photographed by a digital camera. Further, the image forming apparatus using the photoreceptor belt produced high-quality 2,000 A4 images without deterioration of image density.

### Example 25

An aluminum drum was cut with a diamond cutting tool to have a diameter of 90 mm, a length of 352 mm and a thickness of 2.5 mm.

15 parts of an acrylic resin (ACRYDIC A-460-60 from Dainippon Ink And Chemicals, Inc.) and 10 parts of a melamine resin (Super Bekkamin L-121-60 from Dainippon Ink And Chemicals, Inc.) were dissolved in 80 parts of methyl ethyl ketone to prepare a solution. 90 parts of titanium oxide powder (TM-1 from Fuji Titanium Industry Co., Ltd.) were added thereto and dispersed therein with a ball mill for 72 hrs to prepare an undercoat layer coating liquid. The aluminum drum having a rough surface was dipped therein and vertically pulled up at a constant speed. The aluminum drum was dried at 140° C. for 20 min in a drying chamber while a direction thereof is maintained to form an undercoat layer having a thickness of 2.0 μm thereon.

Next, 15 parts of a butyral resin (S-LEC BLS from Sekisui Chemical Co., Ltd.) were dissolved in 150 parts of cyclohexanone to prepare a solution, and 10 parts of a tris azo pigment having the following formula (1) were added thereto and dispersed in a ball mill for 60 hrs.

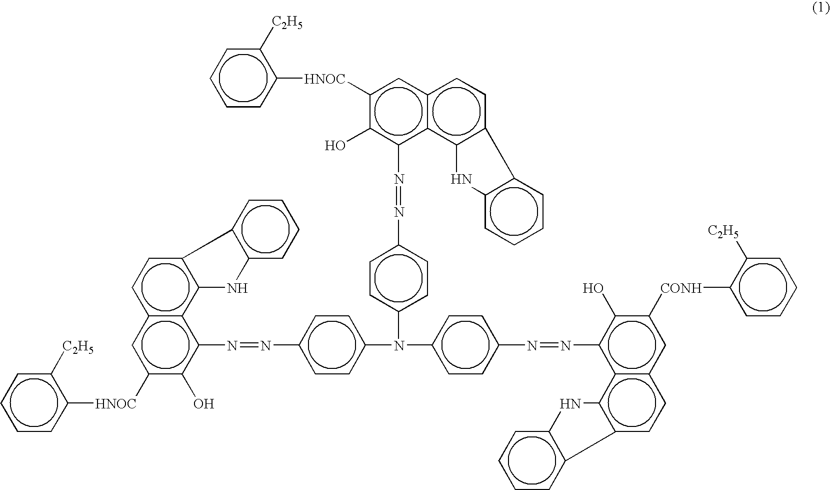

Further, 210 parts of cyclohexanone were added thereto and dispersed for 5 hrs., and the dispersed mixture was diluted with cyclohexanone while stirred to have a solid content of 1.5% by weight. The aluminum drum the undercoat layer is formed on was dipped in the thus prepared charge generation layer coating liquid, and pulled up at a constant speed. The dipped aluminum drum the undercoat layer is formed on was dried at 120° C. for 20 min similarly to forming the undercoat layer to form a charge generation layer having a thickness of 0.2 μm thereon.

Further 6 parts of a charge transport material having the following formula (4), 10 parts of a polycarbonate resin (Panlite K-1300 from TEIJIN CHEMICALS LTD.) and 0.002 parts of a silicone oil (KF-50 from Shin-Etsu Chemical Co., Ltd.) were dissolved in 90 parts of methylene chloride to prepare a charge transport layer coating liquid.

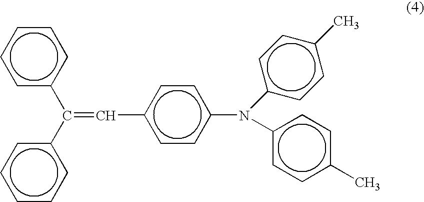

The aluminum drum the undercoat layer and charge generation layer are formed on was dipped in the thus prepared charge transport layer coating liquid, and pulled up at a constant speed. The dipped aluminum drum was dried at 120° C. for 20 min similarly to forming the undercoat layer to form a charge transport layer having a thickness of 23 μm on the charge generation layer.

The thus prepared photoreceptor was covered with the polyolefin laminate film 6, and which was heat-sealed to seal in the photoreceptor.

Then, the sealed-in photoreceptor was stored at 10° C. for 2 years. The sealed-in photoreceptor left for 4 hrs at a room temperature after stored produced a high-quality image of a test chart of a portrait snap picture and a landscape picture through an image forming apparatus imagio color 2800 using a multilevel writing method from Ricoh Company, Ltd. High-quality 1,200 images without deterioration of image density were produced thereby.

### Examples 26 and 27

The following materials were mixed in aball mill pot using an alumina ball having a diameter of 10 mm for 72 hrs to prepare a milled liquid.

| | |
|---|---|
| Titanium oxide | 50.0 |
| (CR-60 from ISHIHARA SANGYO KAISHA, LTD.) | |
| Alkyd resin | 15.0 |
| (Bekkolite M6401-50 from Dainippon Ink And Chemicals, Inc.) | |
| Melamine resin | 10.0 |
| (Super BekkaminL-121-60 from Dainippon Ink And | |
| Chemicals, Inc.) | |
| Methyl ethyl ketone (from KANTOU KAGAKU) | 31.7 |

105.0 parts of cyclohexanone (from KANTOU KAGAKU) were added to the milled liquid, and the liquid is further milled for 2 hrs to prepare an under coat layer coating liquid. A nickel seamless belt (having a Vickers hardness of from 480 to 510 and a purity not less than 99.2%) having a peripheral length of 290.3 mm and a thickness of 30 μm was dipped in the undercoat layer coating liquid, and the dipped nickel seamless belt was dried at 135° C. for 25 min to form an undercoat layer having a thickness of 6.0 μm thereon.

The following materials were mixed in a ball mill pot using an agate ball having a diameter of 10 mm for 72 hrs to prepare a milled liquid.

| | |
|---|---|
| Charge generation material from Ricoh Company, Ltd. having the following formula (1): | 1.5 |

| | |
|---|---|
| 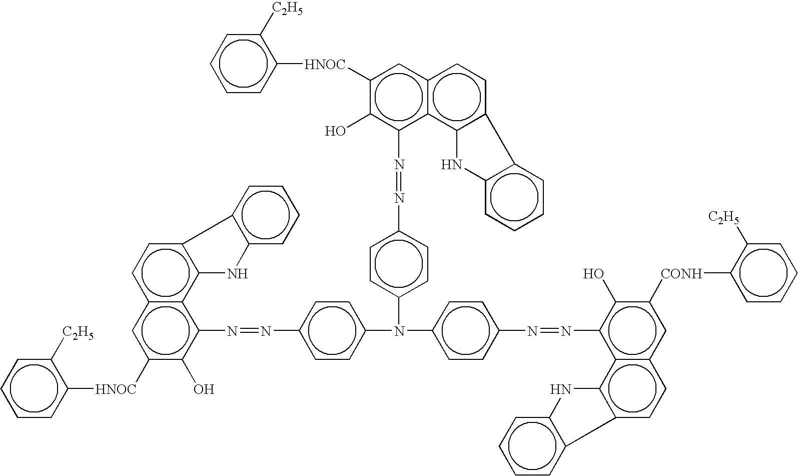 | (1) |

| | |
|---|---|
| Charge generation material from Ricoh Company, Ltd. having the following formula (2): | 1.5 |

| | |
|---|---|
| 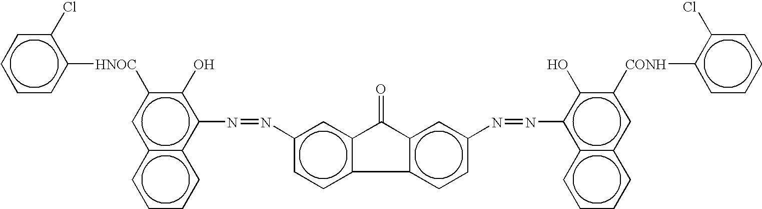 | (2) |

| | |
|---|---|
| Polyvinylbutyral resin (S-LEC BLS from Sekisui Chemical Co., Ltd.) | 1.0 |
| Cyclohexanone (from KANTOU KAGAKU) | 80.0 |

Further, 78.4 parts of cyclohexanone and 237.6 parts of methyl ethyl ketone were added to the milled liquid to prepare a charge generation layer coating liquid. The nickel seamless belt the undercoat layer was coated on was dipped therein, and the dipped nickel seamless belt was dried at 130° C. for 20 min to form a charge generation layer having a thickness of 0.12 μm thereon.

Next, a charge transport layer coating liquid including the following constituents was prepared.

| | |
|---|---|
| Charge transport material | 7 |
| from Ricoh Company, Ltd. having the following formula (3): | |
| 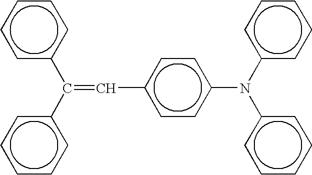 | (3) |
| Polycarbonate resin | 10 |
| (C-1400 from TEIJIN CHEMICALS LTD.) | |
| Silicone oil | 0.002 |
| (KF-50 from Shin-Etsu Chemical Co., Ltd.) | |
| Dichloromethane (KANTOU KAGAKU) | 830 |

The charge transport layer coating liquid was spray-coated on the nickel seamless belt the undercoat layer and charge generation layer were coated on while rotated, and the spray-coated nickel seamless belt was dried at 140° C. for 30 min to form a charge transport layer having a thickness of 25 μm thereon.

Three 50 mm×60 mm pieces were cut out from the thus prepared photoreceptor as samples for measuring electrostatic properties thereof. The 3 photoreceptors with samples were stored in 3 storage members having an abstract with n-hexane of 420 ppm (Example 26), 1,190 ppm (Example 27) and 1,550 ppm (Comparative Example 8), respectively. The storage member was formed of 2 laminate films with the polyethylene film inside, the four sides of which were heat-sealed, and wherein the photoreceptors and sample were sealed. Then, the sealed-in photoreceptor samples were stored at 41° C. and 55% RH for 20 days. After stored, sensitivities of the photoreceptors and samples were measured with a measurer for electrostatic properties EPA-8100 from Kawaguchi Electric Works, Co., Ltd. at 25° C. An irradiation quantity until a surface potential of the photoreceptor was reduced to −400 V and −160 V after charged to have a potential of −800 V and irradiated with light having a wavelength o f780 nm were measured to determine a sensitivity thereof.

The test results of Examples 26 and 27 and Comparative Example 8 shown in Table 6 prove that a specified amount or less of the abstract with n-hexane decreases sensitivity deterioration of photoreceptors even after stored at a high temperature for a short period.

Further, the above-mentioned test samples in Example 26 and Comparative Example 8 were repeatedly charged and irradiated 1,000 times a minute for 1.5 hrs such that a sample current of −5.6 μA passes through the sample when having a charge potential of −800 V. The irradiation quantity until a surface potential of the photoreceptor was reduced to −160 V after charged to have a potential of −800 V was 0.86 μJ/cm² and 1.50 μJ/cm² for the test samples in Example 26 and Comparative Example 8, respectively.

This proves that a specified amount or less of the abstract with n-hexane decreases sensitivity deterioration of photoreceptors as well.

### Example 28

The photoreceptor sample prepared in Example 26 was stored in a storage member having an abstract with n-hexane of 450 ppm. The storage member was formed of the 2 laminate films including 3 layers of a nylon film, an aluminum film and a polyethylene film, the four sides of which were heat-sealed, and wherein the photoreceptor sample was sealed.

Then, the sealed-in photoreceptor sample was stored at 23° C. and 65% RH for 4 years. After stored, sensitivity of the photoreceptor sample was measured by the same method in Examples 26 and 27.

The test results of Example 28 in Table 6 prove that a specified amount or less of the extract with n-hexane decreases sensitivity deterioration of photoreceptors stored at a pertinent temperature even after stored for long periods, i.e., not less than an year.

TABLE 6

| | | Irradiation | Irradiation |
|---|---|---|---|
| | Extract with | quantity to | quantity to |
| | n-hexane (ppm) | −400 V (μJ/cm²) | −160 V (μJ/cm²) |
| Example 26 | 420 | 0.33 | 0.72 |
| Example 27 | 1,190 | 0.33 | 0.73 |
| Comparative | 1,550 | 0.35 | 0.81 |
| Example 8 | | | |
| Example 28 | 450 | 0.35 | 0.75 |

### Example 29

The photoreceptor belt prepared in Example 26 was stored in a storage member having an abstract with n-hexane of 320 ppm. The storage member was formed of the 2 laminate films including 3 layers of a nylon film, an aluminum film and a polyethylene film, the four sides of which were heat-sealed, and wherein the photoreceptor belt was sealed. Then, the sealed-in photoreceptor belt was stored at 10 for 4 years. After stored, sensitivity of the photoreceptor sample was measured by the same method in Examples 26 and 27.

The photoreceptor belt after stored installed in an image forming apparatus IPSiO Color 5100 using a multilevel writing method from Ricoh Company, Ltd. produced a high-quality image including a portrait photographed by a digital camera. Further, the image forming apparatus using the photoreceptor belt produced high-quality 2,000 A4 images without deterioration of image density.

The test results proves that a specified amount or less of the extract with n-hexane decreases sensitivity deterioration of photoreceptors stored at a pertinent temperature even after stored for long periods, i.e., not less than an year, and that sufficient quality thereof can be maintained as replacement parts for image forming apparatus.

### Example 30

An aluminum drum was cut with a diamond cutting tool to have a diameter of 90 mm, a length of 352 mm and a thickness of 2.5 mm. 15 parts of an acrylic resin (ACRYDIC A-460-60 from Dainippon Ink And Chemicals, Inc.) and 10 parts of a melamine resin (Super Bekkamin L-121-60 from Dainippon Ink And Chemicals, Inc.) were dissolved in 80 parts of methyl ethyl ketone to prepare a solution. 90 parts of titanium oxide powder (TM-1 from Fuji Titanium Industry Co., Ltd.) were added thereto and dispersed therein with a ball mill for 72 hrs to prepare an undercoat layer coating liquid. The aluminum drum having a rough surface was dipped therein and vertically pulled up at a constant speed. The aluminum drum was dried at 140° C. for 20 min in a drying chamber while a direction thereof is maintained to form an undercoat layer having a thickness of 2.0 μm thereon.

Next, 15 parts of a butyral resin (S-LEC BLS from Sekisui Chemical Co., Ltd.) were dissolved in 150 parts of cyclohexanone to prepare a solution, and 10 parts of a tris azo pigment having the following formula (1) were added thereto and dispersed in a ball mill for 60 hrs.

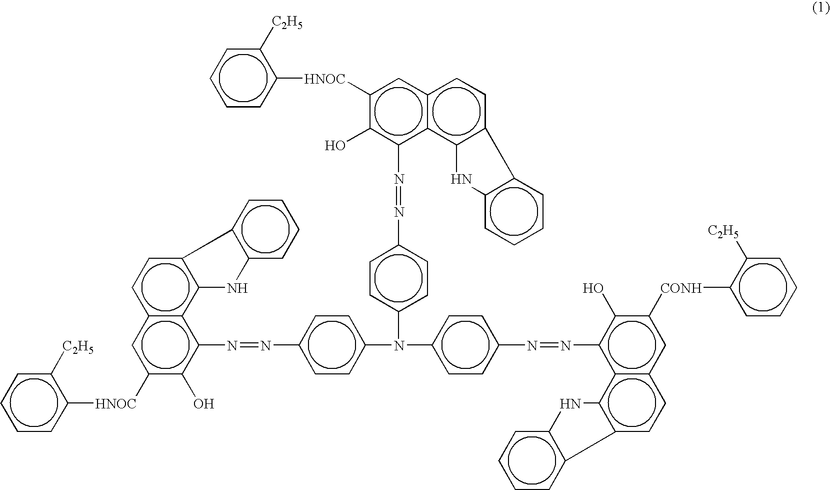

Further, 210 parts of cyclohexanone were added thereto and dispersed for 5 hrs, and the dispersed mixture was diluted with cyclohexanone while stirred to have a solid content of 1.5% by weight. The aluminum drum the undercoat layer is formed on was dipped in the thus prepared charge generation layer coating liquid, and pulled up at a constant speed. The dipped aluminum drum the undercoat layer is formed on was dried at 120° C. for 20 min similarly to forming the undercoat layer to form a charge generation layer having a thickness of 0.2 μm thereon.

Further 6 parts of a charge transport material having the following formula (4), 10 parts of a polycarbonate resin (Panlite K-1300 from TEIJIN CHEMICALS LTD.) and 0.002 parts of a silicone oil (KF-50 from Shin-Etsu Chemical Co., Ltd.) were dissolved in 90 parts of methylene chloride to prepare a charge transport layer coating liquid.

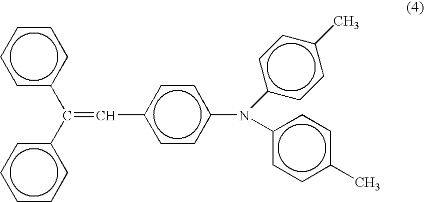

The aluminum drum the undercoat layer and charge generation layer are formed on was dipped in the thus prepared charge transport layer coating liquid, and pulled up at a constant speed. The dipped aluminum drum was dried at 120° C. for 20 min similarly to forming the undercoat layer to form a charge transport layer having a thickness of 23 μm on the charge generation layer.

The thus prepared photoreceptor drum was stored in a storage member having an abstract with n-hexane of 290 ppm. The storage member was formed of the 2 laminate films including 3 layers of a nylon film, an aluminum film and an ionomer polyethylene film, the four sides of which were heat-sealed, and wherein the photoreceptor drum was sealed.

Then, the sealed-in photoreceptor drum was stored at 10 for 2 years. The sealed-in photoreceptor drum left for 4 hrs at a room temperature after stored produced a high-quality image of a test chart of a portrait snap picture and a landscape picture through an image forming apparatus imagio color 2800 using a multilevel writing method from Ricoh Company, Ltd. High-quality 1,200 images without deterioration of image density were produced thereby.

The test results of Example 30 prove that a specified amount or less of the extract with n-hexane decreases sensitivity deterioration of photoreceptors stored at a pertinent temperature without an influence of dew condensation due to a difference of temperature even after stored for long periods, i.e., not less than an year, and that sufficient quality thereof can be maintained as replacement parts for image forming apparatus.

This application claims priority and contains subject matter related to Japanese Patent Applications Nos. 2004-119067, 2004-360338, 2004-202817 and 2004-176477, filed on Apr. 14, 2004, Dec. 13, 2004, Jul. 9, 2004 and Jun. 15, 2004 respectively, the entire contents of each of which are hereby incorporated by reference.

Having now fully described the invention, it will be apparent to one of ordinary skill in the art that many changes and modifications can be made thereto without departing from the spirit and scope of the invention as set forth therein.

1. A method of storing a photoreceptor to be used in an image forming apparatus after removal from storage, comprising:
disposing the photoreceptor in a polyolefin film, and
maintaining the photoreceptor and the polyolefin film at a temperature not higher than 23° C. for not less than an year.

2. The method of claim 1, further comprising:
using a chlorinated solvent to prepare the photoreceptor.

3. The method of claim 1, wherein the photoreceptor comprises a photosensitive layer including a charge generation material, the charge generation material having an azo pigment.

4. The method of claim 1, further comprising:
removing the photoreceptor from the polyolefin film for installation in the image forming apparatus that uses a multilevel writing method.

5. The method of claim 1, wherein the photoreceptor is configured to be detachably mounted to the image forming apparatus.

6. The method of claim 1, further comprising:
assembling a process cartridge including the photoreceptor.

7. A method of storing a photoreceptor configured to be used in an image forming apparatus, comprising:
sealing the photoreceptor in a storage member comprising an polyolefin film and a metallic film bonded with one another through an adhesive layer with the polyolefin film adjacent the photoreceptor, the polyolefin film and the adhesive layer comprising an organic solvent having a boiling point not higher than 120° C. in an amount of not more than 120 ppm.

8. The method of claim 7, wherein the organic solvent is one of alcohols, carboxylic acids and esters.

9. The method of claim 7, wherein the organic solvent is one of ethanol, acetic acids and ethyl acetate.

10. The method of claim 7, wherein the adhesive layer has a thickness from 0.1 to 5 μm.

11. The method of claim 7, further comprising:
maintaining the photoreceptor at a temperature not higher than 23° C. for not less than an year.

12. The method of claim 7, further comprising:
removing the photoreceptor from the storage member for installation in the image forming apparatus that uses a multilevel writing method.

13. The method of claim 7, wherein the photoreceptor comprises a photosensitive layer including a charge generation material, the charge generation material having an azo pigment.

14. The method of claim 7, further comprising:
using a chlorinated solvent to prepare the photoreceptor.

15. The method of claim 7, wherein the photoreceptor is configured to be detachably mounted to the image forming apparatus.

16. The method of claim 7, further comprising:
assembling a process cartridge including the photoreceptor.

17. A method of storing a photoreceptor configured to be used in an image forming apparatus, comprising:
sealing the photoreceptor in a laminate film comprising a polyolefin film and a first film, the polyolefin film being formed by polylaminating an innermost side of the laminate film.

18. The method of claim 17, wherein the laminate film further comprises a metallic film, and the metallic film is laminated on an outermost side of the polyolefin film.

19. The method of claim 17, further comprising:
maintaining the photoreceptor at a temperature not higher than 23° C. for not less than an year.

20. The method of claim 17, further comprising:
removing the photoreceptor from the laminate film for installation in the image forming apparatus that uses a multilevel writing method.

21. The method of claim 17, wherein the photoreceptor comprises a photosensitive layer including a charge generation material, the charge generation material having an azo pigment.

22. The method of claim 17, further comprising:
using a chlorinated solvent to prepare the photoreceptor.

23. The method of claim 17, wherein the photoreceptor is configured to be detachably mounted to the image forming apparatus.

24. The method of claim 17, further comprising:
assembling a process cartridge including the photoreceptor.

25. A method of storing a photoreceptor configured to be used in an image forming apparatus, comprising:
sealing the photoreceptor in a laminate film comprising a polyolefin film, a first film, and an adhesive layer, the polyolefin film formed on an innermost side of the laminate film through the adhesive layer on the first film, and the adhesive layer formed without using an organic solvent.

26. The method of claim 25, wherein the laminate film further comprises a metallic film, and the metallic film is laminated on the outer side of the polyolefin film.

27. The method of claim 25, further comprising:
forming the adhesive layer by a non-solvent laminating method.

28. The method of claim 25, further comprising:
forming the adhesive layer by a poly-sand laminating method.

29. The method of claim 25, further comprising:
maintaining the photoreceptor at a temperature not higher than 23° C. for not less than an year.

30. The method of claim 25, further comprising:
removing the photoreceptor from the laminate film for installation in the image forming apparatus that uses a multilevel writing method.

31. The method of claim 25, wherein the photoreceptor comprises a photosensitive layer comprising a charge generation material, the charge generation material having an azo pigment.

32. The method of claim 25, further comprising:
using a chlorinated solvent to prepare the photoreceptor.

33. The method of claim 25, wherein the photoreceptor is configured to be detachably mounted to the image forming apparatus.

34. The method of claim 25, further comprising:
assembling a process cartridge including the photoreceptor.

35. A method of storing a photoreceptor configured to be used in an image forming apparatus, comprising:
sealing the photoreceptor in a laminate film comprising a polyolefin film and a first film, the polyolefin film formed on an innermost side of the laminate film, and the laminate film having an extract not greater than 1,300 ppm when subjected to n-hexane.

36. The method of claim 35, wherein the laminate film further comprises a metallic film, and the metallic film is laminated on the outer side of the polyolefin film.

37. The method of claim 35, wherein the polyolefin film comprises a high-pressure processed low-density polyethylene.

38. The method of claim 36, wherein the laminate film comprises an adhesive layer, the polyolefin film and the metallic film are bonded with each other through the adhesive layer, and the polyolefin film and the adhesive layer comprise an organic solvent having a boiling point not higher than 120° C. in an amount not more than 120 ppm.

39. The method of claim 35, further comprising:
bonding the polyolefin film and the first film with each other by a polylaminating method.

40. The method of claim 36, wherein the laminate film further comprises an adhesive layer between the polyolefin film and the metallic film, and the adhesive layer is formed without using an organic solvent.

41. The method of claim 40, further comprising:
forming the adhesive layer by a non-solvent laminating method.

42. The method of claim 40, further comprising:
forming the adhesive layer by a poly-sand laminating method.

43. The method of claim 35, further comprising:
maintaining the photoreceptor at a temperature not higher than 23° C. for not less than an year.

44. The method of claim 35, further comprising:
removing the photoreceptor from the laminate film for installation in the image forming apparatus that uses a multilevel writing method.

45. The method of claim 35, wherein the photoreceptor comprises a photosensitive layer including a charge generation material, the charge generation material having an azo pigment.

46. The method of claim 35, further comprising:
using a chlorinated solvent to prepare the photoreceptor.

47. The method of claim 35, wherein the photoreceptor is configured to be detachably mounted to the image forming apparatus.

48. The method of claim 35, further comprising:
assembling a process cartridge including the photoreceptor.

49. A storage member configured to store a photoreceptor without degradation, comprising:
a polyolefin film disposed on an interior of the storage member;
an adhesive layer disposed on the polyolefin film; and
a metallic film disposed on the adhesive layer,
wherein at least one of the polyolefin film and the adhesive layer comprises an organic solvent having a boiling point not higher than 120° C. in an amount of not more than 120 ppm.

50. The storage member according to claim 49, wherein both of the polyolefin film and the adhesive layer comprise an organic solvent having a boiling point not higher than 120° C. in an amount of not more than 120 ppm.

51. The storage member according to claim 49, wherein the storage member has an extract not greater than 1,300 ppm when subjected to n-hexane.
